(19) United States
(12) Patent Application Publication
(10) Pub. No.: US 2016/0171090 A1
(43) Pub. Date: Jun. 16, 2016

(54) Systems and Methods for Collaborative Project Analysis

(71) Applicant: University of Connecticut, Farmington, CT (US)

(72) Inventors: Daniel Schwartz, Tolland, CT (US); Joseph Patrick O'Shea, Norwich, CT (US)

(73) Assignee: University of Connecticut, Farmington, CT (US)

(21) Appl. No.: 14/965,444

(22) Filed: Dec. 10, 2015

Related U.S. Application Data
(60) Provisional application No. 62/090,560, filed on Dec. 11, 2014.

(51) Int. Cl. G06F 17/30; G06F 17/27

(52) U.S. Cl. CPC G06F 17/30604; G06F 17/3053; G06F 17/2705; G06F 17/30554

(57) ABSTRACT

Systems and methods are presented herein which utilize a database storing for each of a plurality of objects, object-keyword relationship information directly or indirectly relating the object to one or more keywords in order to determine, for at least a first keyword in the database, one or more related keywords. For example, the one or more related keywords may be determined based on first determining one or more objects related to the at least a first keyword based on the object-keyword relationship information for the at least at least a first keyword and then determining the one or more related keywords based the object-keyword relationship information for one or more objects related to the at least a first keyword.

### CROSS-REFERENCE TO RELATED APPLICATION

The present application claims priority benefit to a provisional patent application entitled “Systems and Methods for Collaborative Project Analysis,” which was filed on Dec. 11, 2014, and assigned Ser. No. 62/090,560. The entire content of the foregoing provisional application is incorporated herein by reference.

### TECHNICAL FIELD

The subject application relates to data analytics and, in particular, to software-implemented data analytics.

### BACKGROUND

The ability to network and collaborate with other people is critical in almost any setting and is particularly important in the world of research and academia. Whether it be a student interested in finding a lab for undergraduate or graduate research; a faculty member searching for a colleague with a particular expertise or instrumentation; a grant specialist seeking to find faculty appropriate for a grant opportunity; a journalist seeking to find faculty in a particular discipline for a media story; a journal/granting agency seeking to find peer reviewers on a particular topic; an administrator seeking to understand research trends within the university; a donor seeking to fund research on a particular topic; etc., the ability to identify and reach out to the right people is a must. Thus, there exists a need for systems and methods for promoting and improving collaboration, e.g., in a university setting. Moreover, there exists a need for simple intuitive systems and methods for analyzing people and connections within an organization, e.g., in order to identify the right people with the right expertise for a particular purpose, or to understand trends that could better inform institutional investment decisions These and other needs are met by the systems and methods of the present disclosure.

### SUMMARY

Systems and methods are presented herein for performing data analytics. More particularly, systems and methods are presented herein for analyzing data related to collaborative efforts between entities.

In exemplary embodiments, systems are provided including a non-transient storage medium, the storage medium storing in a database, for each of a plurality of objects, object-keyword relationship information directly or indirectly relating the object to one or more keywords and a processor in communication with the non-transient storage medium, the processor configured to execute instructions for determining, for at least a first keyword in the database, one or more related keywords. For example, the one or more related keywords may be determined based on first determining one or more objects related to the at least a first keyword based on the object-keyword relationship information for the at least at least a first keyword and then determining the one or more related keywords based on the object-keyword relationship information for one or more objects related to the at least a first keyword.

In some embodiments, the objects in the database may represent entities, e.g., wherein the object-keyword relationship information is entity-keyword relationship information. Notably, such entities may be real world entities. For example, the entities may be entities in a university or other scholastic or scholarly setting, such as faculty members, student members and/or administration members. Alternatively, exemplary entities may be entities in a research and development setting (e.g., a corporate research and development setting), such as researchers and/or management. In yet other exemplary embodiments, the entities may be entities in a healthcare setting, such as healthcare providers, administrators and/or healthcare recipients.

In exemplary embodiments, the objects in the database may represent projects, e.g., wherein the object-keyword relationship information is project-keyword relationship information. Notably, these projects may be real world projects. In some embodiments, the projects may be projects in a university or other scholastic or scholarly setting, e.g., including publications, grants and/or other research initiatives or deliverables. As noted above, the project-keyword relationship information may be automatically derived by a processor that engages in analysis of data relating to each project, e.g., using semantic analysis and/or metadata analysis.

In exemplary embodiments, the entity-keyword relationship information for each entity may include information directly relating the entity to the one or more keywords. In other embodiments, the entity-keyword relationship information for each entity may include: (i) entity-project information directly relating the entity to one or more projects where the entity is a contributing entity, and (ii) project-keyword relationship information directly relating each project to one or more keywords. The project-keyword relationship information may be automatically derived by a processor engaging in analysis of data relating to each project, e.g., via semantic analysis and/or metadata analysis.

In some embodiments, the storage medium may also store in the database, for each of the plurality of objects, object-object relationship information directly or indirectly relating the object to one or more related objects. For example, the objects may be entities in a collaborative environment wherein the object-object relationship information is entity-entity relationship information which directly or indirectly relates each entity to one or more collaborative entities. Thus, the entity-entity relationship information for each entity may include information directly relating the entity to the one or more collaborative entities. Alternatively, the entity-entity relationship information for each entity may include entity-project information relating the entity to one or more projects where the entity is a contributing entity, and wherein the one or more collaborative entities for each entity are one or more other contributing entities to the one or more projects related to the entity. In yet other embodiments, the entity-entity relationship information for each entity may include entity-entity group information relating the entity to one or more entity groups where the entity is a member, wherein the one or more collaborative entities for each entity are one or more other member entities to the one or more entity-groups related to the entity. Notably, the collaborative entities for an entity may represent other entities that have collaborated with that entity at some point in the past.

In some embodiments, the objects may be projects in a collaborative environment wherein the object-object relationship information is project-project relationship information which directly or indirectly relates each project to one or more related projects. Thus, for example, the project-project relationship information for each project may include information directly relating the project to one or more related projects. Alternatively, the project-project relationship information for each project may include project-entity information relating the project to one or more contributing entities to that project, wherein the one or more related projects for each project are one or more other projects related to the contributing entities to the project. In yet other embodiments, the project-project relationship information for each project may include project-project group information relating the project to one or more project groups where the project is a part thereof, and wherein the one or more related projects for each project are one or more other projects in the one or more project-groups related to the project.

In some embodiments, a step of determining the one or more objects related to the at least a first keyword may include determining a primary set of one or more objects related to the at least a first keyword based on the object-keyword relationship information for the at least a first keyword, and further determining a secondary set of additional objects related to the primary set of objects based on the object-object relationship information.

In exemplary embodiments, a step of determining one or more related keywords may include determining a ranking of a set of related keywords. For example, determining the one or more related keywords may include applying a threshold to the ranking of the set of related keywords so as to produce (i) a subset of a predetermined maximum number of keywords; (ii) a subset of a predetermined minimum number of keywords; and/or (iii) a subset of those keywords ranked above a certain value. In some embodiments, the object-keyword relationship information may include a weighting factor for each object-keyword relationship, wherein the ranking of the plurality of related keywords is based at least in part on the weighting factors. Note that the object-keyword relationship information may include two different weighting factors for each object-keyword relationship, depending on whether the relationship is from the perspective of the object to the keyword or from the perspective of the keyword to the object.

In some embodiments, the processor is configured to receive the at least a first keyword as a user input in a query. Notably, the processor may be automatically configured to parse a query input to determine when the query includes one or more keywords. Advantageously, in some embodiments, related keyword information may be precompiled for each keyword in the database, prior to processing the query. In exemplary embodiments, the processor may be configured to identify a plurality of entities based on the query. For example, the identification of a plurality of entities may be based on determining one or more entities related to the at least a first keyword, e.g., based on entity-keyword relationship information stored in the database. Advantageously, the entity-keyword relationship information may be precompiled for each keyword in the database, prior to processing the query.

In some embodiments, the identification of the plurality of entities may include determining a ranking of a set of entities related to the at least a first keyword. The identification of the plurality of entities may further include applying a threshold to the ranking of the set of related entities, e.g., using (i) a subset of a predetermined maximum number of entities; (ii) a subset of a predetermined minimum number of entities; and/or (iii) a subset of those keywords ranked above a certain value. The entity-keyword relationship information may include a weighting factor for each entity-keyword relationship, wherein the ranking of the set of entities related to the at least a first keyword is based at least in part on the weighting factors. It is noted that the entity-keyword relationship information may include two different weighting factors for each entity-keyword relationship, depending on whether the relationship is from the perspective of the entity to the keyword or from the perspective of the keyword to the entity.

In exemplary embodiments, the processor may be further configured to determine for each entity in the identified plurality of entities collaborative relationships relative to each of the other entities in the plurality of entities. In some embodiments, systems may further include a display to graphically depict the identified plurality of entities and the collaborative relationships between the entities. For example, entities may be visually indicated by points and collaborative relationships may be indicated by connections between sets of points.

In exemplary embodiments, the display may visually depict a word cloud of the related keywords in addition to depicting the identified plurality of entities and the collaborative relationships between the entities. Notably, the depicted word cloud of related keywords and the graphical depiction of the identified plurality of entities and the collaborative relationships between the entities may be interrelated such that a user selection in one depiction is automatically reflected in the other depiction. For example, a user selection of a keyword in the keyword cloud may automatically filter the graphical depiction of the identified plurality of entities and the collaborative relationships between the entities to display only those entities and relationships associated with that keyword. Similarly, a user selection of an entity or relationship in the graphical depiction of the identified plurality of entities and the collaborative relationships between the entities may automatically filter the word cloud to include only those keywords associated with the selected entity or relationship. In some embodiments, the display may also depict a set of projects associated with the identified plurality of entities.

In other embodiments, methods are provided for determining, for at least a first keyword in a database, one or more related keywords. In particular, the one or more related keywords may be determined based on, e.g., determining one or more objects related to the at least a first keyword based on object-keyword relationship information for the at least at least a first keyword and determining the one or more related keywords based the object-keyword relationship information for one or more objects related to the at least a first keyword.

In yet other embodiments, methods are disclosed for facilitating analysis of a collaborative setting by, e.g., receiving a query including at least a first keyword, determining one or more entities related to the at least a first keyword based on entity-keyword relationship information stored in a database, determining one or more related keywords for the at least a first keyword such as described above, and displaying interactive interdependent depictions of a keyword cloud of the related keywords and a graphical representation of the identified plurality of entities and collaborative relationships between the entities.

### BRIEF DESCRIPTION OF THE DRAWINGS

A more complete understanding of the present disclosure and certain advantages thereof may be acquired by referring to the following description in consideration with the accompanying drawings, in which like reference numbers indicate like features.

FIG. 1 depicts a screenshot of an exemplary query interface according to the present disclosure.

FIG. 2 depicts a screenshot of an exemplary entity results interface according to the present disclosure.

FIGS. 3-4 depict screenshots illustrating various interactive features of the exemplary entity results interface of FIG. 2 according to the present disclosure.

FIGS. 5 and 6 depict top and bottom portions of a screenshot illustrating exemplary analytics features for a query according to the present disclosure.

FIG. 7 depicts a screenshot of an exemplary entity profile interface according to the present disclosure.

FIG. 8 depicts a screenshot of an exemplary customizable and interactive data feed interface according to the present disclosure.

FIGS. 9-11 depict screenshots that illustrate exemplary analytics tools according to the present disclosure.

FIGS. 12-14 depict screenshots illustrating operation of a keyword analyzer model according to the present disclosure.

FIG. 15 depicts a screenshot of a social platform interface providing tools for collaborating with other users in real time according to the present disclosure.

FIG. 16 depicts an exemplary data model according to the present disclosure.

FIG. 17 is a block diagram of an exemplary network environment suitable for a distributed implementation of exemplary embodiments according to the present disclosure.

### DETAILED DESCRIPTION

In the following description of various exemplary embodiments, reference is made to the accompanying drawings, which form a part hereof, and in which are shown by way of illustration various example devices, systems, and environments in which aspects of exemplary embodiments disclosed herein may be practiced. It is to be understood that other specific arrangements of parts, example devices, systems, and environments may be utilized and structural and functional modifications may be made without departing from the scope of the present disclosure.

Systems and methods are presented herein performing data analytics. More particularly, systems and methods are presented herein for analyzing data related to collaborative efforts between entities.

Data Model:

In exemplary embodiments, the systems and methods of the present disclosure may utilize a database which may store data relating to a plurality of entities, a plurality of projects and relationships between entities and projects. For example, the database may store, for each entity, an entity ID (such as a name of the entity) and other characterizing information for the entity. Similarly, the database may store, for each project, a project ID (such as a project name) and other characterizing information for the project. Advantageously, each project may be associated with one or more entities representing a group of collaborators for that particular project. Moreover, each entity may be associated with one or more projects representing a body of work for that particular entity. Thus, for example, the database may store, for each entity ID, relationships between that entity ID and one or more project IDs. Similarly, the database may store, for each project ID, relationships between that project ID and one or more entity IDs. In exemplary embodiments wherein the database implements a relational data model, data relating to relationships between entities and projects may be stored, e.g., using a many-to-many junction table relating entity IDs and project IDs.

In some embodiments, entities and/or projects may be weighted, for example, to reflect a degree of importance of a given entity (e.g., relative to other entities) and/or to reflect a degree of importance of a given project (e.g., relative to other projects). Thus, in some embodiments, each entity ID and/or each project ID may be associated with a weight factor. The weight factor for an entity may, for example, reflect factors such as entity experience/recognition (e.g., based on age, years of experience, total number of projects, entity position, status, and/or accolades, entity costs/funding such as over in a given period and/or other objective or subjective criteria), and/or other factors relating to a degree of importance of the given entity. The weight factor for a project may, for example, reflect factors such as project scope (e.g., based on start and end dates for the project, costs/funds allocated the project, deliverables attributable to the project, and/or other objective or subjective criteria), temporal relevancy of the project (e.g., based on start or end dates of the project, and/or other objective or subjective criteria) and/or other factors relating to a degree of importance of a given project-entity relationship to the entity.

In further embodiments, relationships between entities and projects may be weighted, for example, to reflect a degree of importance of a given project-entity relationship to the entity and/or to the project. Thus, in some embodiments, each entity ID/project ID pair (entity ID, project ID) may be associated with a relationship weight factor for the entity and/or a relationship weight factor for the project. The relationship weight factor for the entity may, for example, reflect factors such as project scope for the portion contributed by the entity (e.g., based on start and end dates for the entity working on the project, costs/funds allocated to the entity for the project, deliverables attributable to the entity for the project, and/or other objective or subjective criteria), temporal relevancy of the project to the entity (e.g., based on start or end dates for the entity working on the project, a chronological ranking relative to other projects for the entity, and/or other objective or subjective criteria) and/or other factors relating to a degree of importance of the given project-entity relationship to the entity. The relationship weight factor for the project may, for example, reflect factors such as entity contribution percentage/significance (e.g., based on a percentage of project attributable to the entity, a percentage of total costs/funds allocated to the entity for the project, relative contribution of deliverables (e.g., first authorship credits and the like), and/or other objective or subjective criteria) and/or other factors relating to a degree of importance of the given project-entity relationship to the project. In some embodiments, a single weight factor may be used to reflect a degree of importance of a given project-entity relationship to both the entity and the project.

In exemplary embodiments, the database may further store data relating to entity groups and relationships between entity groups and entities. For example, the database may store, for each entity group, an entity group ID (such as a name of the entity group) and other characterizing information for the entity group. In exemplary embodiments, each entity group may be associated with one or more entities while each entity may only be associated with a single entity group. Thus, for example, the database may store, for each entity group ID, relationships between that entity group ID and one or more entity IDs. In exemplary embodiments wherein the database implements a relational data model, data relating to relationships between entity groups and entity may be stored, e.g., by including in the data for each entity (each entity ID) a reference to an entity group (entity group ID). This represents a many to one data structure between the entities and entity groups.

In alternative embodiments, each entity group may be associated with one or more entities and each entity may be associated with one or more entity groups. Thus, for example, the database may store, for each entity group ID, relationships between that entity group ID and one or more entity IDs. Similarly, the database may store, for each entity ID, relationships between that entity ID and one or more entity group IDs. In exemplary embodiments wherein the database implements a relational data model, data relating to relationships entity groups and entities may be stored, e.g., using a many-to-many junction table relating entity group IDs and entity IDs.

In some embodiments, entity groups may be weighted, for example, to reflect a degree of importance of a given entity group (e.g., relative to other entity groups). Thus, in some embodiments, each entity group ID may be associated with a weight factor. The weight factor for an entity group may, for example, reflect factors such as entity group recognition (e.g., based entity group status, and/or accolades, entity group costs/funding such as over in a given period and/or other objective or subjective criteria), and/or other factors relating to a degree of importance of the given entity.

In further embodiments, relationships between entity groups and entities may be weighted, for example, to reflect a degree of importance of a given entity group-entity relationship to the entity group and/or to the entity. Thus, in some embodiments, each entity group ID/entity ID pair (entity group ID, entity ID) may be associated with a relationship weight factor for the entity group and/or a relationship weight factor for the entity. The relationship weight factor for the entity group may, for example, reflect factors such as entity position/status within the entity group and and/or other factors relating to a degree of importance of the given entity group-entity relationship to the entity group. The relationship weight factor for the entity may, for example, reflect factors such as a degree of participation of the entity in the entity group, e.g., relative to participation of the entity in other entity groups and/or other factors relating to a degree of importance of the given entity group-entity relationship to the entity. In some embodiments, a single weight factor may be used to reflect a degree of importance of a given entity group-entity relationship to both the entity group and the entity.

In exemplary embodiments, the database may further store data relating to relationships between entity groups and projects. For example, each entity group may be associated with one or more projects and each project may be associated with one or more entity groups. Thus, for example, the database may store, for each entity group ID, relationships between that entity group ID and one or more project IDs. Similarly, the database may store, for each project ID, relationships between that project ID and one or more entity group IDs. In exemplary embodiments wherein the database implements a relational data model, data relating to relationships between entity groups and projects may be stored, e.g., using a many-to-many junction table relating entity group IDs and project IDs.

In some embodiments, relationships between entity groups and projects may be weighted, for example, to reflect a degree of importance of a given entity group-project relationship to the entity group and/or to the project. Thus, in some embodiments, each entity group ID/project ID pair (entity group ID, entity ID) may be associated with a relationship weight factor for the entity group and/or a relationship weight factor for the project. In some embodiments, a single weight factor may be used to reflect a degree of importance of a given entity group-project relationship to both the entity group and the project.

In exemplary embodiments, the database may further store data relating to project groups and relationships between project groups and projects. For example, the database may store, for each project group, a project group ID (such as a name of the project group) and other characterizing information for the project group. In exemplary embodiments, each project group may be associated with one or more projects while each project may only be associated with a single project group. Thus, for example, the database may store, for each project group ID, relationships between that project group ID and one or more project IDs. In exemplary embodiments wherein the database implements a relational data model, data relating to relationships between project groups and projects may be stored, e.g., by including in the data for each project (each project ID) a reference to a project group (project group ID). This represents a many to one data structure between the projects and project groups.

In alternative embodiments, each project group may be associated with one or more projects and each project may be associated with one or more project groups. Thus, for example, the database may store, for each project group ID, relationships between that project group ID and one or more project IDs. Similarly, the database may store, for each project ID, relationships between that project ID and one or more project group IDs. In exemplary embodiments wherein the database implements a relational data model, data relating to relationships between project groups and projects may be stored, e.g., using a many-to-many junction table relating projects group IDs and project IDs.

In some embodiments, project groups may be weighted, for example, to reflect a degree of importance of a given project group (e.g., relative to other project groups). Thus, in some embodiments, each project group ID may be associated with a weight factor. In further embodiments, relationships between project groups and projects may be weighted, for example, to reflect a degree of importance of a given project group-project relationship to the project group and/or to the project. Thus, in some embodiments, each project group ID/project ID pair (project group ID, project ID) may be associated with a relationship weight factor for the project group and/or a relationship weight factor for the project. In some embodiments, a single weight factor may be used to reflect a degree of importance of a given project group-project relationship to both the project group and the project.

In exemplary embodiments, the database may further store data relating to keywords and relationships between keywords and entities, projects, entity groups and/or project groups. In general, keywords are semantically descriptive of key topics and ideas associated with the entities, projects, entity groups and/or project groups. In exemplary embodiments, the database may store, for each keyword, a keyword ID (such as the keyword itself) and other characterizing information for the entity. Advantageously, each keyword may be associated with one or more entities, projects, entity groups and/or project groups. Thus, for example, the database may store, for each keyword ID, relationships between that keyword ID and one or more entity IDs, project IDs, entity group IDs and/or project group IDs. In exemplary embodiments wherein the database implements a relational data model, data relating to relationships between keywords and entities, projects, entity groups and/or project groups may be stored, e.g., using many-to-many junction table(s) relating keyword IDs relative to entity IDs, project IDs, entity group IDs and/or project group IDs. Alternatively, keywords may be stored as a string or array of keywords associated with each entity, project, entity group and/or project group. In some embodiments the database may further store data interrelating to keywords. Thus, the database may include for example a semantic engine for determining synonymous keywords or other relationships between keywords.

In some embodiments, keywords may be weighted, for example, to reflect a degree of importance of a given keyword (e.g., relative to other keywords). Thus, in some embodiments, each keyword ID may be associated with a weight factor. In further embodiments, relationships between keywords and entities, projects, entity groups and/or project groups may be weighted, for example, to reflect a degree of importance of a given keyword relationship. For example, keyword relationships to a particular project may be weighted based on their relative degree of importance to that project.

In exemplary embodiments, the database may further store data relating to relationships between project groups and entities. For example, each project group may be associated with one or more entities and each entity may be associated with one or more project groups. Thus, for example, the database may store, for each project group ID, relationships between that project group ID and one or more entity IDs. Similarly, the database may store, for each entity ID, relationships between that entity ID and one or more project group IDs. In exemplary embodiments wherein the database implements a relational data model, data relating to relationships between project groups and entities may be stored, e.g., using a many-to-many junction table relating project group IDs and entity IDs.

In some embodiments, relationships between project groups and entities may be weighted, for example, to reflect a degree of importance of a given project group-entity relationship to the project group and/or to the entity. Thus, in some embodiments, each project group ID/entity ID pair (project group ID, entity ID) may be associated with a relationship weight factor for the project group and/or a relationship weight factor for the entity. In some embodiments, a single weight factor may be used to reflect a degree of importance of a given project group-entity relationship to both the project group and the entity.

In exemplary embodiments, the database may further store data relating to relationships between project groups and entity groups. For example, each project group may be associated with one or more entity group and each entity group may be associated with one or more project groups. Thus, for example, the database may store, for each project group ID, relationships between that project group ID and one or more entity group IDs. Similarly, the database may store, for each entity group ID, relationships between that entity group ID and one or more project group IDs. In exemplary embodiments wherein the database implements a relational data model, data relating to relationships between project groups and entity groups may be stored, e.g., using a many-to-many junction table relating project group IDs and entity group IDs.

In some embodiments, relationships between project groups and entity groups may be weighted, for example, to reflect a degree of importance of a given project group-entity group relationship to the project group and/or to the entity group. Thus, in some embodiments, each project group ID/entity group ID pair (project group ID, entity group ID) may be associated with a relationship weight factor for the project group and/or a relationship weight factor for the entity group. In some embodiments, a single weight factor may be used to reflect a degree of importance of a given project group-entity group relationship to both the project group and the entity group.

In exemplary embodiments, systems and methods presented herein may be applied in a university or other R&D setting, for example, for the purposes of analyzing collaborative efforts on research projects between researchers. Thus, in example embodiments, entities stored in the database may be researchers (such as faculty members, students, employees or other people associated with a given research project) and projects stored in the database may be research projects (such as grants, publications, presentations, new product developments, or the like). Also, entity groups may be stored in the database to reflect groups of researches (such as departments, teams, geographic/facility groupings, or the like). Moreover, project groups may be stored in the database to reflect groups of research projects (such as relating to a common funding/grant). It is noted however, that even though illustrated embodiments described herein focus on the research/university setting the systems and methods of the present disclosure are not limited such specific implementations. Rather the systems and methods described herein may be used to facilitate analysis of any type of collaborative projects in any setting.

Populating the Data Model:

In exemplary embodiments, the systems and methods of the present disclosure may utilize underlying data sources to populate the data model, e.g., automatically. Thus, in some embodiments, the systems and methods of the present disclosure may implement a parser module is to convert source data from an input format into a well-defined data model in memory, e.g., such as the data model described herein. In some embodiments, the parser module may implement a modular parser interface. This modular parser interface advantageously may allow new data formats to be easily supported without major changes to the system (to support a new data format, one must simply write a parser for that format which breaks down the data into atomic pieces of data). Potential data sources which the parsing module can be configured to accommodate include (but are not limited to): text files, web scraping, external APIs, user input, and the like.

The systems and methods of the present disclosure are capable of utilizing any number of different data sources to populate the data model. In exemplary implementations, the system and methods may analyze data associated with authored (e.g., published) works. Therefore, an exemplary abstraction of an appropriate data source may be any list of authored works which includes metadata about each included work. In exemplary embodiments, each work processed may be characterized by the following metadata: Author(s), Author Affiliation(s), Title and Year. The systems and methods may also utilize various optional metadata if they are available, such as: Keyword lists, Origin of publication (e.g., journals in the case of academic publications), Abstract text/synopsis/summary, Full text, ISSN/DOI, Volume, issue, page numbers.

In general, each work processed may include one or more form(s) of data relating to the content/subject area of the work. For example, an underlying source may include as metadata a list of keywords related to the content/subject area of the work. Alternatively, or in conjunction therewith the parser interface may include support for pulling/deriving, e.g., based on a contextual analysis, keywords relating to the content/subject area of the work from the work itself (such as from the abstract or the text of the work). Notably, relative weight factors for the extrapolated keyword entity relationships may also be determined, e.g., based on a scoring algorithm for relevance. Example data fields from which keywords may be obtained include, for example: Title, Keyword lists (e.g., metadata or otherwise), Abstract/synopsis/summary, Full text, and the like. Notably, availability of a greater number of these data fields will lead to better keyword identification and, consequently, more useful search results.

Data Analytics:

The systems and methods enable performing data analytics on the data stored in the database or data warehouse, e.g., relating to the entities, projects, entity groups and/or project groups. In some embodiments, the systems and methods are configured to receive a query as user input, e.g., a keyword input or other input. For example, a query may include identifying and ranking relevant entities based on a keyword input.

Advantageously, the systems and methods may reduce processing time by precompiling and storing information related to predetermined types of queries. In some embodiments, a separate database (e.g., a MongoDB database) may be employed for storing information related to predetermined query results. The precompiling of information may advantageously enable near real time data analytics for end users.

In exemplary embodiments, the following information may be precompiled and stored as relating to entities (for example, for each entity (entity ID) in the database the following information may be determined and stored):
Keyword Scores and Top Keywords—For each keyword (keyword ID) in the database, a score may be calculated for that entity keyword pair (entity ID, keyword ID). The score may be calculated based on an analysis of direct keywords associations with the entity and/or based on indirect keyword associations with the entity, such as keyword associations with projects which are associated with the entity, keyword associations with entity groups which are associated with the entity, and/or keywords associations with project groups which are associated with projects which are associated with the entity. For example, a simplistic keyword scoring algorithm may be to score each keyword based on a total number of projects associated with the entity that the keyword is related to. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity keyword pairs (entity ID, keyword ID) for the entity are then ranked by score. In exemplary embodiments, only a top subset of the keywords based on score is stored for each entity in the database. For example, a subset of keywords may be determined based on a minimum score threshold and/or a top N number of keywords based on score.
Collaborators—For each potential collaborative entity (“collaborator”) in the database (which may be each entity other than the entity in question) a score may be calculated for that entity collaborator pair (entity ID, collaborator ID). The score may be calculated based on an analysis of indirect associations between the entity and the collaborator, such as the entity and the collaborator being associated with same projects, project groups, entity groups, sets of keywords or the like. For example, a simplistic collaboration scoring algorithm may be to score each collaborator based on a total number of common projects (a total number of projects associated with both the entity and the collaborator). In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity collaborator pairs (entity ID, collaborator ID) for the entity are then ranked by score. In exemplary embodiments, only a top subset of the collaborators based on score is stored for each entity in the database. For example, a subset of collaborators may be determined based on a minimum score threshold and/or a top N number of collaborators based on score.
Project counts—for each project type in the database, a yearly score may be computed for that entity project type pair (entity ID, project type). This score may be calculated based on the number of projects of the given type which the entity is associated with for a given year or range of years. For example, a simplistic project counting algorithm may be to simply count the number of projects the entity is associated with (across all years).

Other exemplary information which may be compiled for each entity may include project scores and top projects, entity group scores and top entity groups, and/or project group scores and top project groups.

In exemplary embodiments the following information may be precompiled and stored as relating to projects (for example, for each project (project ID) in the database the following information may be determined and stored):
Keyword Scores and Top Keywords—For each keyword (keyword ID) in the database, a score may be calculated for that project keyword pair (project ID, keyword ID). The score may be calculated based on an analysis of direct keywords associations with the project and/or based on indirect keyword associations with the project, such as keyword associations with entities which are associated with the project, keyword associations with project groups which are associated with the project, and/or keywords associations with entity groups which are associated with entities which are associated with the project. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All project keyword pairs (project ID, keyword ID) for the project are then ranked by score. In exemplary embodiments, only a top subset of the keywords based on score is stored for each project in the database. For example, a subset of keywords may be determined based on a minimum score threshold and/or a top N number of keywords based on score.
Collaborators—For each potential related project in the database (which may be each project other than the project in question) a score may be calculated for that project related project pair (project ID, related project ID). The score may be calculated based on an analysis of indirect associations between the project and the related project, such as the project and the related project being associated with same entities, entity groups, project groups, sets of keywords or the like. For example, a simplistic related project scoring algorithm may be to score each related project based on a total number of common entities (a total number of entities associated with both the project and the related project). In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All project related project pairs (project ID, related project ID) for the project are then ranked by score. In exemplary embodiments, only a top subset of the related projects based on score is stored for each project in the database. For example, a subset of related projects may be determined based on a minimum score threshold and/or a top N number of related projects based on score.

Other exemplary information which may be compiled for each project may include entity scores and top entities, entity group scores and top entity groups, and/or project group scores and top project groups.

In exemplary embodiments the following information may be precompiled and stored as relating to keywords (for example, for each keyword (keyword ID) in the database the following information may be determined and stored):
Entity Scores and Top Entities—For each entity (entity ID) in the database, a score may be calculated for that keyword entity pair (keyword ID, entity ID). The score may be calculated based on an analysis of direct entity associations with the keyword and/or based on indirect entity associations with the keyword, such as entity associations with projects which are associated with the keyword, entity associations with entity groups which are associated with the keyword, and/or entity associations with projects which are associated with projects groups which are associated with the keyword. For example, a simplistic entity scoring algorithm may be to score each entity based on a total number of projects associated with the entity that the keyword is related to. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All keyword entity pairs (keyword ID, entity ID) for the keyword in question are then ranked by score. In exemplary embodiments, only a top subset of the entities based on score is stored for each keyword in the database. For example, a subset of entities may be determined based on a minimum score threshold and/or a top N number of entities based on score.
Notably, in some embodiments the scoring algorithm for determining a score for entity relationships to a keyword may be the same scoring algorithm for determining a score for keyword relationships to an entity (e.g., a score for a keyword entity pair (keyword ID, entity ID) may be the same as the score for the corresponding entity keyword pair (entity ID, keyword ID)). Alternatively, for example, on account of weighting factors differing based on the directionality of a relationship, the scoring algorithms may be different. This reflects the fact that a degree of importance of an entity to a keyword may be different than a degree of importance of a keyword to an entity.
Project Scores and Top projects—For each project (project ID) in the database, a score may be calculated for that keyword project pair (keyword ID, project ID). The score may be calculated based on an analysis of direct project associations with the keyword and/or based on indirect project associations with the keyword, such project associations with entities which are associated with the keyword, project associations with project groups which are associated with the keyword, and/or project associations with entities which are associated with entity groups which are associated with the keyword. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All keyword project pairs (keyword ID, project ID) for the keyword are then ranked by score. In exemplary embodiments, only a top subset of the projects based on score is stored for each keyword in the database. For example, a subset of projects may be determined based on a minimum score threshold and/or a top N number of projects based on score.

Notably, in some embodiments the scoring algorithm for determining a score for project relationships to a keyword may be the same scoring algorithm for determining a score for keyword relationships to an project (e.g., a score for a keyword project pair (keyword ID, project ID) may be the same as the score for the corresponding project keyword pair (project ID, keyword ID)). Alternatively, for example, on account of weighting factors differing based on the directionality of a relationship, the scoring algorithms may be different. This reflects the fact that a degree of importance of an project to a keyword may be different than a degree of importance of a keyword to a project.
Related Keywords—For each potential related keyword in the database (which may be each keyword other than the keyword in question) a score may be calculated for that keyword related keyword pair (keyword ID, related keyword ID). The score may be calculated based on an analysis of direct association between keywords (such as semantic relationship) and/or based on indirect associations between the keyword and the related keyword, such as the keyword and the related keyword being associated with same entities, projects, entity groups, project groups or the like. For example, a simplistic related keyword scoring algorithm may be to score each related keyword based on a total number of entities which are related to both the keyword in question and the related keyword. In other embodiments, a simplistic related keyword scoring algorithm may be to score each related keyword based on a total number of entities in the Top Entities (as previously determined) which are associated with the related keyword. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All keyword related keyword pairs (keyword ID, related keyword ID) for the keyword are then ranked by score. In exemplary embodiments, only a top subset of the related keywords based on score is stored for each keyword in the database. For example, a subset of related keywords may be determined based on a minimum score threshold and/or a top N number of related keywords based on score.

In exemplary embodiments, related keywords for a given keyword may be determined based on a set of top entities determined for the given keyword. Thus, for example the top related keywords may be a subset of keywords, e.g., a subset of the top keywords, associated with the entities in set of top entities. Thus, e.g., a score for a related keyword may be determined, e.g., based on a cumulative score of the related keyword as reflected in the top keywords for each of the entities in the top entities.
Entity collaborations—For each (keyword, entity ID) pair in the database, a score may be calculated for each potential entity collaborator tuple (entity ID, collaborator ID, keyword ID) for collaboration on the given keyword (collaborator ID may be each entity other than the entity in question). The score may be calculated based on an analysis of indirect associations between the entity and the collaborator which relate to the given keyword, such as the entity and the collaborator being associated with same projects, project groups, entity groups, or the like which contain the keyword. For example, a simplistic collaboration scoring algorithm may be to score each collaborator based on a total number of common projects (a total number of projects associated with both the entity and the collaborator) which contain the specific keyword. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity collaborator pairs (entity ID, collaborator ID) for the keyword are then ranked by score. In exemplary embodiments, only a top subset of the collaborators based on score is stored for each keyword in the database. For example, a subset of collaborators may be determined based on a minimum score threshold and/or a top N number of collaborators based on score.
Entity group collaborations—For each (keyword, entity group ID) pair in the database, a score may be calculated for each potential entity group collaborator tuple (entity group ID, collaborator group ID, keyword ID) for collaboration on the given keyword (collaborator ID may be each entity group other than the entity group in question). The score may be calculated based on an analysis of indirect associations between the entity group and the collaborator group which relate to the given keyword, such as the entity group and the collaborator group being associated with same projects, project groups, or the like which contain the keyword. For example, a simplistic collaboration scoring algorithm may be to score each collaborator group based on a total number of common projects (a total number of projects associated with both the entity group and the collaborator group) which contain the specific keyword. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity group collaborator pairs (entity group ID, collaborator group ID) for the keyword are then ranked by score. In exemplary embodiments, only a top subset of the collaborator groups based on score is stored for each keyword in the database. For example, a subset of collaborator groups may be determined based on a minimum score threshold and/or a top N number of collaborator groups based on score.
Location Scores and Top Locations—For each location (location ID) in the database, a score may be calculated for that keyword location pair (keyword ID, location ID). The score may be calculated based on an analysis of direct keywords associations with the location and/or based on indirect keyword associations with the location, such as keyword associations with entities which are associated with the location, keywords associations with entities which are associated with entity groups which are associated with the location, and/or keywords associations with projects which are associated with entities which are associated with projects which are associated with the location.
Yearly scores—for each keyword in the database, a yearly score may be computed for that keyword year pair (keyword ID, year). This score may be calculated based on the number of projects containing the given keyword for a given year or range of years. For example, a simplistic algorithm may be to count the number of projects the keyword is occurs in the given year.

Other exemplary information which may be compiled for each keyword may include entity group scores and top entity groups, and/or project group scores and top project groups.

In exemplary embodiments the following information may be precompiled and stored as relating to entity groups (for example, for each entity group (entity group ID) in the database the following information may be determined and stored):
Keyword Scores and Top Keywords—For each keyword (keyword ID) in the database, a score may be calculated for that entity group keyword pair (entity group ID, keyword ID). The score may be calculated based on an analysis of direct keywords associations with the entity group and/or based on indirect keyword associations with the entity group, such as keyword associations with entities which are associated with the entity group, keywords associations with projects which are associated with entities which are associated with the entity group, and/or keywords associations with project groups which are associated with projects which are associated with entities which are associated with the entity group. For example, a simplistic keyword scoring algorithm may be to score each keyword based on keyword scores as reflected in the top keywords for each entity in the entity group (as previously determined). In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity group keyword pairs (entity group ID, keyword ID) for the entity group are then ranked by score. In exemplary embodiments, only a top subset of the keywords based on score is stored for each entity group in the database. For example, a subset of keywords may be determined based on a minimum score threshold and/or a top N number of keywords based on score.
In exemplary embodiments, the top keywords for an entity group may be a subset of keywords, e.g., a subset of the top keywords, associated with the entities in the entity group. Thus, e.g., a score for a keyword with respect to an entity group may be determined, e.g., based on a cumulative score for the keyword as reflected in the top keywords for each of the entities in the entity group.
Entity Scores and Top Entities—For each entity (entity ID) in the database, a score may be calculated for that entity group entity pair (entity group ID, entity ID). The score may be calculated based on an analysis of direct entity associations with the entity group and/or based on indirect entity associations with the entity group, such as common keyword associations, common project associations and the like. For example, a simplistic keyword scoring algorithm may be calculated based on the frequency with each entity participated in projects under an affiliation with the given entity group. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity group entity pairs (entity group ID, entity ID) for the entity group are then ranked by score. In exemplary embodiments, only a top subset of the entities based on score is stored for each entity group in the database. For example, a subset of entities may be determined based on a minimum score threshold and/or a top N number of entities based on score.
Collaborators—For each potential collaborative group in the database (which may be each entity group other than the entity group in question) a score may be calculated for that entity group collaborative group pair (entity group ID, collaborative group ID). The score may be calculated based on an analysis of indirect associations between the entity group and the collaborative group, such as the entity group and the collaborative group being associated with same entities, projects, project groups, sets of keywords or the like. For example, a simplistic collaboration scoring algorithm may be to score each collaborative group based on a total number of common entities (a total number of entities associated with both the entity group and the collaborative group). An alternative collaboration scoring algorithm may be to score each collaborative group based on a total number of common projects (a total number of projects associated with both the entity group and the collaborative group). In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All entity group collaborative group pairs (entity group ID, collaborative group ID) for the entity group are then ranked by score. In exemplary embodiments, only a top subset of the collaborative groups based on score is stored for each entity group in the database. For example, a subset of collaborative groups may be determined based on a minimum score threshold and/or a top N number of collaborative groups based on score.
Project counts—for each project type in the database, a yearly score may be computed for that entity group project type pair (entity group ID, project type). This score may be calculated based on the number of projects of the given type which the entity group is associated with for a given year or range of years. For example, a simplistic project counting algorithm may be to simply count the number of projects the entity group is associated with (across all years).

Other exemplary information which may be compiled for each entity group may include project scores and top projects, and/or project group scores and top project groups.

In exemplary embodiments the following information may be precompiled and stored as relating to project groups (for example, for each project group (project group ID) in the database the following information may be determined and stored):
Keyword Scores and Top Keywords—For each keyword (keyword ID) in the database, a score may be calculated for that project group keyword pair (project group ID, keyword ID). The score may be calculated based on an analysis of direct keywords associations with the project group and/or based on indirect keyword associations with the project group, such as keyword associations with projects which are associated with the project group, keywords associations with entities which are associated with projects which are associated with the project group, and/or keywords associations with entity groups which are associated with entities which are associated with projects which are associated with the project group. For example, a simplistic keyword scoring algorithm may be to score each keyword based on keyword scores as reflected in the top keywords for each project in the project group (as previously determined). In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, project groups, project groups, keywords and/or relationships (such as relationships between keywords and entities, keywords and projects, keywords and project groups, keywords and project groups, projects and entities, entities and project groups, projects and project groups, and the like) may be considered as part of the scoring algorithm. All project group keyword pairs (project group ID, keyword ID) for the project group are then ranked by score. In exemplary embodiments, only a top subset of the keywords based on score is stored for each project group in the database. For example, a subset of keywords may be determined based on a minimum score threshold and/or a top N number of keywords based on score.
In exemplary embodiments, the top keywords for a project group may be a subset of keywords, e.g., a subset of the top keywords, associated with the projects in the project group. Thus, e.g., a score for a keyword with respect to an project group may be determined, e.g., based on a cumulative score for the keyword as reflected in the top keywords for each of the projects in the project group.
Project Scores and Top Projects—For each project (project ID) in the database, a score may be calculated for that project group project pair (project group ID, project ID). The score may be calculated based on an analysis of direct project associations with the project group and/or based on indirect project associations with the project group, such as common keyword associations, common entity associations and the like. In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All project group project pairs (project group ID, project ID) for the project group are then ranked by score. In exemplary embodiments, only a top subset of the projects based on score is stored for each project group in the database. For example, a subset of projects may be determined based on a minimum score threshold and/or a top N number of projects based on score.
Related Project Groups—For each potential related project group in the database (which may be each project group other than the project group in question) a score may be calculated for that project group related project group pair (project group ID, related project group ID). The score may be calculated based on an analysis of indirect associations between the project group and the related project group, such as the project group and the related project group being associated with same projects, entities, entity groups, sets of keywords or the like. For example, a simplistic related project group scoring algorithm may be to score each related project group based on a total number of common projects (a total number of projects associated with both the project group and the related project group). An alternative related project scoring algorithm may be to score each related project group based on a total number of common entities (a total number of entities associated with both the project group and the related project group). In some embodiments the scoring algorithm may be a machine learned scoring algorithm, e.g., based on a support vector machine (SVM), decision tree, regression, neural network or other type of analysis. In exemplary embodiments, weighting factors, for example, weighting factors associated with entities, projects, entity groups, project groups, keywords and/or relationships (such as relationships between keywords and entities, keywords and projects, keywords and entity groups, keywords and project groups, projects and entities, entities and entity groups, projects and project groups, and the like) may be considered as part of the scoring algorithm. All project group related project group pairs (project group ID, related project group ID) for the project group are then ranked by score. In exemplary embodiments, only a top subset of the related project groups based on score is stored for each project group in the database. For example, a subset of related project groups may be determined based on a minimum score threshold and/or a top N number of related project groups based on score.

Other exemplary information which may be compiled for each project group may include entity scores and top entities, and/or entity group scores and top entity groups.

More generally, the systems and methods described herein may implement a compilation module which may receive data from a database, e.g., data which was previously parsed and stored by the parsing module from one or more data sources. The compilation module may then precompile the data into appropriate sets of data such as described herein. Compilation may include, for example, compiling information related to: all projects for an entity, all keywords for an entity, all collaborators for an entity, all entity groups for an entity, all project groups for an entity, all entities in an entity group, all projects for an entity group, all keywords for an entity group, all project groups for an entity group, all collaborative groups for an entity group, all entities in a project group, all projects for a project group, all keywords for a project group, all entity groups for a project group, all related project groups for a project group, all projects for a year, all keywords for a year, all entities for a year, and the like.

The systems and methods described herein may also generally implement an analysis module for performing data analytics, e.g., using precompiling of information. Such analysis can range from very simple (ex: what are the top 50 keywords for a given entity?) to quite complex (ex: how many entities relating to keyword X have collaborated with an entity related to keyword Y but not to keyword Z?). The results of these data analyses may advantageously serve as the basis for a reporting/visualization module of the systems and methods described herein. Notably, by storing precompiled data from the compilation module in a database, new analysis modules can build on the compiled information without having to recompile such information.

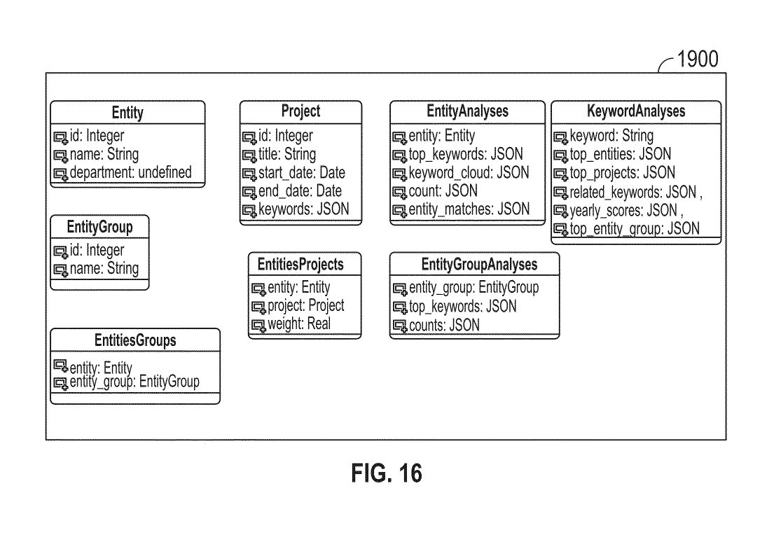

With reference now to FIG. 16 an exemplary data model 1900 is presented including data structures for Entities, Entity Groups, and Projects. The exemplary data model further includes data structures representing relationships between Entities, Entity Groups and Projects. In particular, the data model includes and EntitiesGroups data structure representing relationships between Entities and Entity Groups and an EntitiesProjects data structure representing relationships between Entities and Projects. The exemplary data model also includes analysis data structures for storing precomputed information relating to Entities (EntityAnalysis), Keywords (KeywordAnalysis) and Entity Groups (EntityGroupAnalysis). For example, the EntityAnalysis data structure can include a list of top keywords, a keyword cloud, an entity count, and a list of entity-matches. It will be appreciated that the data model depicted in FIG. 16 is only one possible data model that can be used in implementing the systems and methods described herein.

Exemplary Algorithms:

In exemplary embodiments, the systems and methods described herein may implement various algorithms for processing the data represented in the data model. Exemplary algorithms can include the following:

Algorithms for Project Analyses

An exemplary project keyword algorithm takes as input a single project with enough associated metadata to compute keywords. The output of the algorithm can be a scored list of all keywords in the project. The algorithm can work in two stages: keyword counting and keyword scoring. The keyword counting stage simply counts the number of times each keyword occurs in the project. Different weightings may be given to different sources of keyword (e.g., keywords occurring in the title might have a weight of 2× that of keywords occurring in the project abstract). Normalization of keywords also occurs at this stage. Examples of normalization include, but may be not limited to, converting adverbs into their adjective forms, normalizing plural and singular versions of the same keyword, and normalizing capitalization.

After the counting stage is completed, the keywords may be scored using a series of rules and formulas. The scores given to each keyword reflect its statistical significance in the context of the input project. In one such implementation, a keyword score may be calculated by simply counting the number of occurrences of a given keyword compared to the total number of keyword occurrences in the entire project. In other implementations, a keyword score may be calculated by a probability distribution such as a binomial distribution. In the binomial implementation, scores may be calculated using the following formula:

score=−1*log 10(binomial(k,p,n)) (1)

In exemplary embodiments, k represent the number of occurrences of the given keyword in the input project (binomial successes). In exemplary embodiments, p can represent the occurrence probability for the given keyword across all keywords in the database (binomial probability of success). In exemplary embodiments, n can represent the sum of the number of occurrences for all keywords in the input project (number of binomial trials).

Once scores have been computed for all keywords in the project, the list of scored keywords can be sorted in descending order (highest score to lowest score) and can be stored in the database for use by other algorithms in the system.

Algorithms for Entity Analyses

An exemplary top keywords algorithm takes as input a single entity ID and outputs a list of the top scored keywords for the specified entity. The algorithm uses the entity ID to pull from the database all of the projects associated with the entity. The algorithm begins by summing all the keyword occurrences from all of the entity's projects. This can be done by using the output data of the “Project Keywords” algorithm. Once all the keyword occurrences are summed, keyword scores may be computed using a series of rules and formulas. In one such implementation, a keyword score may be calculated by simply comparing the total number of occurrences of that keyword to the total number of keyword occurrences from all of the entity's projects. In other implementations, a keyword score may be calculated by a probability distribution such as a binomial distribution. In the binomial implementation, scores may be calculated using the following formula:

score=−1*log 10(binomial(k,p,n)) (2)

In exemplary embodiments, k can represent the sum of occurrences of the given keyword in all the entity's projects. In exemplary embodiments, p can represent the occurrence percentage for the given keyword across all keywords in the database and n can represent the sum of the number of occurrences for all keywords in all the entity's projects.

Once scores have been computed for all keywords in the entity's projects, the list of scored keywords can be sorted in descending order (highest score to lowest score) and can be stored in the database for use by other algorithms in the system. In some implementations, this list may be truncated to only include a subset of the highest scoring keywords. This can be done by simply taking the N highest scoring keywords from the sorted list (where N may be any constant integer). This can also be done by computing a significance level and taking only those keywords which scored above the significance level threshold. An example of a formula for one such significance level threshold is:

score_threshold=−1*log 10(a/k) (3)

In exemplary embodiments, k can be the total number of keywords in the entity's total list and a can be the chosen alpha value.

In this example implementation, only keywords with scores above the computed score_threshold value will be kept in the final list of entity top keywords.

Once the list has been computed, scored, and truncated, it can be stored in the database for use by other algorithms and in search results.

An exemplary top collaborators algorithm takes as input a single entity ID and outputs a scored list of all other entities that have collaborated with the specified input entity on any projects. Using the entity ID and a prepared SQL statement, the algorithm finds all projects which the input entity can be associated with, and then finds all other entities on those projects. Each collaborating entity can be given a score, which can be equal to the number of distinct projects on which both the input entity and the collaborating entity may be associated.

Once scores have been computed for all collaborating entities in relation to the input entity, the list of scored entities may be sorted in descending order (highest score to lowest score) and can be stored in the database for use by other algorithms or search results.

An exemplary top collaborators (per keyword) algorithm takes as input a single entity ID and a single keyword ID and outputs a scored list of all other entities that have collaborated with the specified input entity on any projects containing the input keyword. Using the entity ID and prepared SQL statements, the algorithm finds all projects which the input entity can be associated with which contain the input keyword. The algorithm then finds all other entities on those projects. Each collaborating entity can be given a score, which can be equal to the number of distinct projects containing the input keyword on which both the input entity and the collaborating entity are associated.

Once scores have been computed for all collaborating entities in relation to the input entity, the list of scored entities can be sorted in descending order (highest score to lowest score) and can be stored in the database for use by other algorithms or search results.

An exemplary entity counts algorithm takes as input a single entity ID and outputs a set of counts for each year in which there can be data available for the entity. These counts may include: number of projects, number of projects of a particular type, number of citations, etc.

The algorithm can work by starting at the earliest year for which the entity has data available. This can be determined by the lowest year for which a project can be associated with the input entity. The algorithm then iterates over every year from the start year to the current year. For each year, counts may be calculated by simply counting the number of projects, projects of a particular type, etc. that are associated with that entity for that year.

Once counts have been computed for each year for the entity, the list of year counts can be sorted in ascending order by year (lowest year to highest year) and can be stored in the database for use by algorithms or search results.

Entity Group Analyses Algorithms

An exemplary top keywords algorithm takes as input a single Entity Group ID and outputs a list of the top scored keywords for the specified Entity Group. The algorithm uses the Entity Group ID to pull from the database all of the Entity Group's projects, which can be all projects associated with the Entities within the Entity Group. The algorithm begins by summing all the keyword occurrences from all of the Entity Group's projects. This can be done by using the output data of the “Project Keywords” algorithm. Once all the keyword occurrences have been summed, keyword scores may be computed using a series of rules and formulas. In one such implementation, a keyword score may be calculated by simply comparing the total number of occurrences of that keyword to the total number of keyword occurrences from all of the Entity Group's projects. In other implementations, a keyword score may be calculated by a probability distribution such as a binomial distribution. In the binomial implementation, scores may be calculated using the following formula:

score=−1*log 10(binomial(k,p,n)) (4)

In exemplary embodiments, k can be the sum of occurrences of the given keyword in all the Entity Group's projects. In exemplary embodiments, p can be the occurrence percentage for the given keyword across all keywords in the database. In exemplary embodiments, n can be the sum of the number of occurrences for all keywords in all the Entity Group's projects.

Once scores have been computed for all keywords in the Entity Group's projects, the list of scored keywords can be sorted in descending order (highest score to lowest score) and can be stored in the database for use by other algorithms in the system. In some implementations, this list may be truncated to only include a subset of the highest scoring keywords. This can be done by simply taking the N highest scoring keywords from the sorted list (where N may be any constant integer). This can also be done by computing a significance level and taking only those keywords which scored above the significance level threshold. An example of a formula for one such significance level threshold is:

score_threshold=−1*log 10(a/k) (5)

In exemplary embodiments, k can be the total number of keywords in the Entity Group's total list of scored keywords and a can be the chosen alpha value

In this example implementation, only keywords with scores above the computed score_threshold value will be kept in the final list of Entity Group top keywords.

Once the list has been computed, scored, and truncated, it can be stored in the database for use by other algorithms and in search results.

An exemplary top collaborators algorithm takes as input a single Entity Group ID and outputs a scored list of all other Entity Groups that have collaborated with the specified input Entity Group on any projects. Using the Entity Group ID and prepared SQL statements, the algorithm finds all projects which the input Entity Group is associated with, and then finds all other Entity Groups associated with those projects. Each collaborating Entity Group can be given a score that can be equal to the number of distinct projects on which both the input Entity Group and the collaborating Entity Group are associated.

Once scores have been computed for all collaborating Entity Groups in relation to the input Entity Group, the list of scored Entity Groups may be sorted in descending order (highest score to lowest score) and can be stored in the database for use by other algorithms or search results.

An exemplary top collaborators per keyword algorithm takes as input a single Entity Group ID and a single keyword ID and outputs a scored list of all other Entity Groups that have collaborated with the specified input Entity Group on any projects associated with the input keyword. Using the Entity Group ID and prepared SQL statements, the algorithm finds all projects which the input Entity Group is associated with which are associated with the input keyword (e.g., the keyword is in the project's scored keyword list). The algorithm then finds all other Entity Groups associated with those projects. Each collaborating Entity Group can be given a score that can be equal to the number of distinct projects associated with the input keyword on which both the input Entity Group and the collaborating Entity Group are associated.

Once scores have been computed for all collaborating Entity Groups in relation to the input Entity Group, the list of scored Entity Groups can be sorted in descending order (highest score to lowest score) and can be stored in the database for use by other algorithms or search results.

An exemplary entity group counts algorithm takes as input a single Entity Group ID and outputs a set of counts for each year in which there can be data available for the Entity Group. These counts may include: number of projects, number of projects of a particular type, number of citations, etc. The set of projects for an Entity Group can be defined as the set of all projects associated with all Entities which are associated with the Entity Group.

The algorithm can work by starting at the earliest year for which the Entity Group has data available. This can be determined by the lowest year for which a project can be associated with the input Entity Group. The algorithm then iterates over every year from the start year to the current year. For each year, counts may be calculated by simply counting the number of projects, projects of a particular type, etc. that are associated with that Entity Group for that year.

Once counts have been computed for each year for the Entity Group, the list of year counts can be sorted in ascending order by year (lowest year to highest year) and can be stored in the database for use by algorithms or search results.

Keyword Analyses Algorithms

An exemplary top entities algorithm takes as input a single keyword ID and outputs a list of the top scoring entities for that keyword. This algorithm operates by analyzing all projects in the database which are associated with the input keyword (e.g., projects which contain the input keyword in their scored keywords list). For each project containing the input keyword, each entity associated with the project can be assigned a score using the formula:

entity_score=project_score*weight (6)

In exemplary embodiments, project_score can be the score for the input keyword in the given project, and weight can be a weight factor for the entity to project relationship.

After all entities from the set of projects containing the input keyword have been given a score for the input keyword, the algorithm builds a sorted scored list of entities. The list can be scored in descending order (highest score to lowest score) and can be stored in the database for use by other algorithms or in search results.

An exemplary top projects algorithm takes as input a single keyword ID and outputs a list of the top scoring projects for that keyword. The algorithm can work by iterating over every project in the database and finding those which contain the input keyword. Each project can be assigned a score, which may be equal or proportional to the score for the input keyword in the given project (see: “Project Keywords”).

After all projects have been assigned a score for the input keyword, the scored list of projects can be sorted from highest score to lowest score and stored in the database for use by other algorithms or in search results.

An exemplary top locations algorithm takes as input a single keyword ID and outputs a list of the top scoring locations for that keyword. The algorithm can work by using the previously calculated “Top Entities” for the input keyword. Each Entity in the database can be associated with a geographical location, such as a building or campus. In exemplary embodiments, locations are stored as latitude and longitude coordinates which may be calculated from a known address using a geolocation API such as the Google Maps API. The algorithm can work by grouping all entities from the input keyword's “Top Entities” list by their location. A score can be then calculated for each location by summing the scores of all entities at that location.

After all locations have been assigned a score for the input keyword, the scored list of locations can be sorted from highest score to lowest score and stored in the database for use by other algorithms or in search results.

An exemplary yearly scores algorithm takes as input a single keyword ID and outputs a list of (year, score) pairs where the score represents the score for the input keyword for that specific year. The algorithm can work by iterating over all projects in the input keyword's “Top Projects” list. The algorithm groups these projects by year. Then, for each year a score can be calculated by summing the scores for the input keyword in all the projects for that year. If there may be no projects containing the input keyword for a given year, that year can be assigned a score of zero.

After all years have been assigned a score for the input keyword, the scored list of years can be sorted from by year in ascending order (lowest year to highest year) and stored in the database for use by other algorithms or in search results.

An exemplary related keywords algorithm takes as input a single keyword ID and outputs a list of the top scoring related keywords for that input keyword. The algorithm can work by using the pre-computed Keyword Top Entities list for the input keyword and building a list of all projects from any entity on the top entities list. In some implementations, this list of projects can be then filtered to only include projects which contain the input keyword.

After the list of related projects has been compiled, the algorithm continues by building a scored list of related keywords. For each related keyword, the score can be equal to the total number of occurrences of that keyword in all the projects in the compiled list of related projects.

After all related keywords have been assigned a score for the input keyword, the scored list of related keywords can be sorted from highest score to lowest score and stored in the database for use by other algorithms or in search results. The sorted scored list can also be truncated at a certain length to only take the top N related keywords (where N can be a constant integer).

Search Algorithms

An exemplary entity search algorithm can work by using a simple pattern matching routine (e.g. SQL LIKE clause) to generate a list of entity names which match the query entered by the user. Users may select an entity from the list of matches, or they may type the entity name in its entirety to complete their search query.

Once the user has initialized a search for a particular entity, the server will fetch several pre-computed data sets from the database, which may include: Entity Top Keywords, Entity Top Collaborators, and Entity Related Entities (see: “Entity Analyses”). The algorithm then can process these data sets along with additional relational data from the database to build a complete entity search result object containing all data needed by the front-end user interface. The algorithm also performs various normalizations and transformations on the data, such as converting database IDs to human readable names. The server then returns this search result object to the front-end user interface for the user to view and interact with.

An exemplary Entity Group search algorithm can work by using a simple pattern matching routine (e.g. SQL LIKE clause) to generate a list of entity group names which match the query entered by the user. Users may select an entity group from the list of matches, or they may type the entity group name in its entirety to complete their search query.

Once the user has initialized a search for a particular entity group, the server will fetch several pre-computed data sets from the database, which may include: Entity Group Top Keywords, Entity Group Top Collaborators, and Entity Group Related Entity Groups (see: “Entity Group Analyses”). The algorithm then can process these data sets along with additional relational data from the database to build a complete entity search result object containing all data needed by the front-end user interface. The algorithm also performs various normalizations and transformations on the data, such as converting database IDs to human readable names. The server then returns this search result object to the front-end user interface for the user to view and interact with.

An exemplary keyword search algorithm can work by using a simple pattern matching routine (e.g. SQL LIKE clause) to generate a list of keywords which match the query entered by the user. Users may select a keyword from the list of matches, or they may type the keyword in its entirety to complete their search query. If a user enters a keyword that is not available in the database, a list of suggested keyword searches will be provided to the user based on the search query. In some implementations, a list of suggested keywords may be provided to the user based on some relation (semantic or otherwise) to the selected keyword search.

Once the user has initialized a search for a particular keyword, the server will fetch several pre-computed data sets from the database, which may include: Keyword Top Entities, Keyword Top Projects, and Keyword Related Keywords (see: “Keyword Analyses”). The algorithm then can process these data sets along with additional relational data from the database to build a complete keyword search result object containing all data needed by the front-end user interface. The algorithm also performs various normalizations and transformations on the data, such as converting database IDs to human readable names. The server then returns this search result object to the front-end user interface for the user to view and interact with.

Similarly, an exemplary advanced keyword search algorithm can work by using a simple pattern matching routine (e.g. SQL LIKE clause) to generate a list of keywords which match the query entered by the user. When doing an advanced search, users typically may select a keyword from the list of matches to proceed. After selecting the initial keyword, users may continue searching for more keywords via the pattern matching algorithm. As additional keywords may be added, users may then select one of the available Boolean Search Operators (details below) to connect each pair of keywords together. These operators allow users to perform more fine-grained searches, including or excluding particular keywords as they see fit.

Although the algorithms may be presented here use 2 keywords for Boolean search queries for the sake of simplicity, the same algorithms can be extended for any number of keywords and operations (e.g. “motif or kinase and protein”, “motif and kinase and disease not cancer”, “disease or cancer and kinase and motif” can all be a valid keyword queries). Some implementations may define an order of operations, or operator precedence (e.g., “motif and cancer or disease” may have a different result than “motif and disease or cancer”). In these implementations users may insert parentheses to specify a particular order of operations which they may desire (e.g., “motif and (cancer or disease)” instead of “motif and cancer or disease”).

Examples of Boolean Operators for Advanced Keyword Searches:

AND—ex: “motif AND protein”; the semantic meaning of this operator can be “return entities/projects/etc. that are related to both the keyword on the left and the one on the right.” The AND algorithm can work by first loading all the pre-computed data sets for both keywords (similar to Simple Keyword Search). The algorithm then calculates the intersection of all IDs for entries in the pre-computed data sets. Only IDs which may be found in the intersection will be returned in the final search result. The algorithm then calculates AND scores by summing the scores for each entity from each keyword's pre-computed data sets.

Once the algorithm has built the combined data sets from the intersection and sum of the individual data sets, the algorithm can process these data sets along with additional relational data from the database to build a complete keyword search result object containing all data needed by the front-end UI. The algorithm also performs various normalizations and transformations on the data, such as converting database IDs to human readable names. The server then returns this search result object to the front-end UI for the user to view and interact with.

OR—ex: “motif OR protein”; the semantic meaning of this operator can be “return entities/projects/etc. that may be related to either the keyword on the left or the one on the right.” This can be a non-exclusive OR, meaning entities/projects/etc. which may be related to both keywords will also be included. The OR algorithm can work by first loading all the pre-computed data sets for both keywords (similar to Simple Keyword Search). The algorithm then calculates the union of all IDs for entries in the pre-computed data sets. All IDs which may be found in the union will be returned in the final search result. The algorithm then calculates OR scores by taking the highest score for each entity from each keyword's pre-computed data sets. For example, if entity A scores 5 for “motif” and 8 for “protein”, entity A will have a score of 8 for “motif OR protein”.

Once the algorithm has built the combined data sets from the union and max scores of the individual data sets, the algorithm can process these data sets along with additional relational data from the database to build a complete keyword search result object containing all data needed by the front-end UI. The algorithm also performs various normalizations and transformations on the data, such as converting database IDs to human readable names. The server then returns this search result object to the front-end UI for the user to view and interact with.

NOT—ex: “motif NOT protein”; the semantic meaning of this operator can be “return entities/projects/etc. that may be related to the keyword on the left but not the one on the right.” The NOT algorithm can work by first loading all the pre-computed data sets for both keywords (similar to Simple Keyword Search). The algorithm then calculates the set subtraction of all IDs in the pre-computed data sets for the keyword on the right from the IDs in the pre-computed data sets for the keyword on the left. For example, “motif NOT protein” will return all entities/projects/etc. that may be in the pre-computed data sets for “motif” but not in the pre-computed data sets for “protein”. All IDs which may be found in the resulting set will be returned in the final search result. The algorithm calculates NOT scores by taking the score for each entity from the pre-computed data sets for the keyword on the left.

Once the algorithm has built the resulting data sets, the algorithm can process these data sets along with additional relational data from the database to build a complete keyword search result object containing all data needed by the front-end UI. The algorithm also performs various normalizations and transformations on the data, such as converting database IDs to human readable names. The server then returns this search result object to the front-end UI for the user to view and interact with.

Data Visualization and Manipulation:

As noted above, in some embodiments, the systems and methods of the present disclosure may be configured to receive query parameters (such as keywords) as user input. Thus, in exemplary embodiments, a query interface may be provided for setting query parameters using one or more user manipulable fields. At its most basic, a user may be presented with a single entry field for entering in query parameters, e.g., as a string. Entered information may include indicators for parsing the input information into individual query parameters, such as keywords, constraints, fields of view, etc.

In response inputted query parameters the systems and methods of the present disclosure may be configured to provide one or more data visualization interfaces for viewing and tunneling retrieved data.

For example, in some embodiments, one or more inputted query parameters, e.g., inputted keywords, may be used to query a group of entities related to the entered parameters. In example embodiments, the query may utilize precompiled information relating input parameters to precomputed entity scores and/or to precompiled top groups of entities. For example, the query may utilize precompiled information scoring each keyword entity pair (keyword ID, entity ID) to rank entities related to an inputted keyword. In some embodiments, the query may utilize precompiled information associating a set of top entities with each inputted keyword (keyword ID). It is noted that parameter based querying, e.g., keyword based querying, may be conducted based on AND, OR or a combination of AND and OR connectors between parameters. For example, entities may be identified based on relationships existing with both a first keyword parameter and second keyword parameter, based on relationships existing with either a first keyword parameter or a second keyword parameter, or based on relationships existing with both a first keyword parameter and either a second keyword parameter or a third keyword parameter.

One exemplary data visualization interface for viewing and tunneling retrieved data may include an entity results interface. The entity results interface may depict, responsive to an input query, an entity graph interface which is a graphical representation of relationships, e.g., collaborative relationships, between entities in an identified (queried) set of entities. Thus, for example, the entity graph interface may enable visualization of collaborative relationships between a set of top authors identified with respect to a particular set of subject matter keywords. In example embodiments, each entity on an entity graph interface may be visually represented by a node. Nodes may be characterized, e.g., color coded, based on relationships between the entities and entity groups, e.g., based on an author's department. The nodes may further be characterized, e.g., scaled/sized, to reflect each entities score/rank for the queried parameters, e.g., based on an author's level of expertise (“score”) in the inputted subject matter keywords. In some embodiments, relationships between entities, e.g., co-author relationships between authors, may be visually represented by connections between nodes. In example embodiments, precompiled information scoring each entity to collaborator relationship (entity ID, collaborator ID) may be utilized to score relationships between entities in the identified (queried) set of entities, e.g., in the set of top authors. Thus, in some embodiments, the entity graph interface may enable visualization of a set of top collaborations between entities in the identified (queried) set of entities. In some embodiments, a thickness, color and/or other characterization of the connections between nodes may be used to represent a collaboration score between entities, e.g., based on a number of times two authors have co-published.

In exemplary embodiments, an entity results interface may further include or be operatively associated a keyword cloud interface of a set of related keywords such as determined based on the inputted query parameters. For example, related keywords may be identified and scored based on a total number of entities in the identified (queried) set of entities which are associated with each related keyword. The keyword cloud interface may characterize, e.g., arrange, scale, etc., a set of top related keywords based on score. In some embodiments, a keyword cloud interface may interdepend on an entity graph interface, e.g., such that a set of top keywords currently visible in the keyword cloud interface may be computed based on a set of top entities currently visible or selected in the entity graph interface. In some embodiments, selecting (e.g., hovering over, clicking, etc.,) keywords in the keyword cloud interface may run a new query or further modify, e.g., filter/narrow, a previously executed query based on the selected keyword query parameter(s), e.g., resulting in both the entity graph interface and keyword cloud interface being updated based on the updated query parameter(s). In some embodiments, a first form of selection of keywords (e.g., hovering over) may perform a different function than a second form of selection of keywords (e.g., clicking). For example, hovering over a keyword may filter/narrow a previous query whereas clicking on a keyword may run a new query.

In exemplary embodiments the entity graph interface may interact with an associated keyword cloud interface in several ways. A first interaction may occur, e.g., when a user selects, e.g., clicks on, hovers over, etc., nodes within the entity graph interface. Upon selecting one or more nodes, all nodes not directly connected to that nodes may be hidden. In other words, only a selected set of entities and their collaborators will be visible. The keyword cloud interface may likewise be updated to reflect only keyword data associated with the selected entities and their collaborators (e.g., the keyword data corresponds to the entities currently visible on the entity graph interface). In further exemplary embodiments a selection, e.g., double clicking, of a node within the entity graph interface may open an entity profile interface, including relevant information relating to the selected entity.

A second interaction between the keyword cloud interface and the entity graph interface may occur when a user selects, e.g., hovers over, keywords in the keyword cloud interface. Because, e.g., in some embodiments all keywords in the keyword cloud are computed from the entities reflected in the entity interface graph, each entity can be assigned a “contribution score” for each keyword in the keyword cloud. Thus, when a user selects, a keyword, the entity graph interface may update to hide all entities which have a contribution score of 0 and to re-characterize, e.g., re-scale the remaining nodes based on their contribution score.

In exemplary embodiments, an entity results interface may further include or be operatively associated with a related projects interface, including projects related to the identified (queried) set of entities. In exemplary embodiments selections of nodes or connections in entity graph interface and/or selection of keywords in the keyword cloud interface may update the related projects interface to highlight those projects related specifically the selected nodes (entities), connections (collaborations), and/or keywords. Similarly, a selection of, e.g., hovering over or clicking, projects in the related projects interface may update the entity graph interface and keyword cloud interface to reflect, e.g., only visualize, information (e.g., entities, connections, keywords, etc.) related to the selected projects. In some embodiments, a selection of, e.g., double clicking, a particular project in the related projects interface may open a project profile for the selected project. In exemplary embodiments projects in the related projects interface may be depicted/presented using a project graph interface such as described herein.

Another exemplary data visualization interface for viewing and tunneling retrieved data may include a project results interface. The project results interface may depict, responsive to an input query, a project graph interface which is a graphical representation of relationships between projects in an identified (queried) set of projects. Thus, for example, the project graph interface may enable visualization of relationships between a set of top publications identified with respect to a particular set of subject matter keywords. In example embodiments, each project on a project graph interface may be visually represented by a node. Nodes may be characterized, e.g., color coded, based on relationships between the projects and projects groups, e.g., based on common grant information. The nodes may further be characterized, e.g., scaled/sized, to reflect each projects score/rank for the queried parameters, e.g., based on an a project's relevance (“score”) to the subject matter keywords. In some embodiments, relationships between projects may be visually represented by connections between nodes. In example embodiments, precompiled information scoring each project to related project relationship (project ID, related project ID) may be utilized to score relationships between projects in the identified (queried) set of projects, e.g., in the set of top projects. Thus, in some embodiments, the project graph interface may enable visualization of a set of top related projects between projects in the identified (queried) set of projects. In some embodiments, a thickness, color and/or other characterization of the connections between nodes may be used to represent a relevance score between projects. In some embodiments, related projects may be scored, e.g., based shared relationships with entities and/or keywords

In exemplary embodiments, a project results interface may further include or be operatively associated with, e.g., via a single interface window, a keyword cloud interface of a set of related keywords such as determined based on the inputted query parameters. For example, related keywords may be identified and scored based on a total number of projects in the identified (queried) set of projects which are associated with each related keyword. The keyword cloud interface may characterize, e.g., arrange, scale, etc., a set of top related keywords based on score. In some embodiments, a keyword cloud interface may interdepend on a project graph interface, e.g., such that a set of top keywords currently visible in the keyword cloud interface may be computed based on a set of top projects currently visible or selected in the project graph interface. In some embodiments, selecting (e.g., hovering over, clicking, etc.,) keywords in the keyword cloud interface may run a new query or further modify, e.g., filter/narrow, a previously executed query based on the selected keyword query parameter(s), e.g., resulting in both the project graph interface and keyword cloud interface being updated based on the updated query parameter(s). In some embodiments, a first form of selection of keywords (e.g., hovering over) may perform a different function than a second form of selection of keywords (e.g., clicking). For example, hovering over a keyword may filter/narrow a previous query whereas clicking on a keyword may run a new query.

In exemplary embodiments the project graph interface may interact with an associated keyword cloud interface in several ways. A first interaction may occur, e.g., when a user selects, clicks on, hovers over, etc., nodes within the project graph interface. Upon selecting one or more nodes, all nodes not directly connected to that nodes may be hidden. In other words, only a selected set of projects and their related projects will be visible. The keyword cloud interface may likewise be updated to reflect only keyword data associated with the selected projects and their related projects (e.g., the keyword data corresponds to the projects currently visible on the project graph interface). In further exemplary embodiments a selection, e.g., double clicking, of a node within the project graph interface may open a project profile interface, including relevant information relating to the selected project.

A second interaction between the keyword cloud interface and the project graph interface may occur when a user selects, e.g., hovers over, keywords in the keyword cloud interface. Because, e.g., in some embodiments all keywords in the keyword cloud are computed from the projects reflected in the project interface graph, each project can be assigned a “contribution score” for each keyword in the keyword cloud. Thus, when a user selects, a keyword, the project graph interface may update to hide all projects which have a contribution score of 0 and to re-characterize, e.g., re-scale the remaining nodes based on their contribution score.

In exemplary embodiments a project results interface may further include or be operatively associated with a related entities interface, including entities related to the identified (queried) set of projects. In exemplary embodiments selections of nodes or connections in project graph interface and/or selection of keywords in the keyword cloud interface may update the related entities interface to highlight those entities related specifically the selected nodes (projects), connections (relationships between projects), and/or keywords. Similarly, a selection of, e.g., hovering over or clicking, entities in the related entities interface may update the project graph interface and keyword cloud interface to reflect, e.g., only visualize, information (e.g., projects, relationships between projects, keywords, etc.) related to the selected entities. In some embodiments, a selection, e.g., double clicking, a particular entity in the related entities interface may open an entity profile for the selected entity. In exemplary embodiments entities in the related entities interface may be depicted/presented using an entity graph interface such as described herein.

Another exemplary data visualization interface for viewing and tunneling retrieved data, which may be employed by the systems and methods disclosed herein may include an entity profile interface, e.g., for a queried/selected entity. The entity profile interface may typically include general information on the entity, e.g., name, affiliations, contact information, biography information, a profile picture etc., a related projects interface of projects related to the entity, e.g., publications and other projects associated with the entity, and a keyword cloud interface of keywords related to the entity, e.g., keywords directly associated with the entity and/or indirectly associated with the entity such as with associated with projects associated with the entity.

In exemplary embodiments the related projects interface of the entity profile may include a list of projects associated with the given entity. By selecting, e.g., double clicking, a particular project, a project profile interface for that project may be opened. In some embodiments, selecting, e.g., hovering over or single clicking, a particular project in the entity profile may update the keyword cloud interface for the entity profile based on the selected project. In exemplary embodiments projects in the related projects interface may be depicted/presented using a project graph interface such as described herein.

As noted above, an entity profile interface may include a keyword cloud interface which displays a set of top keywords for that entity. In exemplary embodiments, selecting, e.g., clicking, keywords may run a query returning a set of top entities or set of top projects based on the selected keywords. Query results may be viewed and tunneled using, e.g., an entity results interface or project results interface, such as described herein. In further embodiments, selecting, e.g., hovering over, keywords in a keyword cloud interface of an entity profile interface may update the related projects interface to highlight those projects related to the selected keywords.

Another exemplary data visualization interface for viewing and tunneling retrieved data, which may be employed by the systems and methods disclosed herein may include a project profile interface, e.g., for a queried/selected project. The project profile interface may typically include general information on the project, e.g., name, dates, funding, project summary information, accolades, etc., a collaborator interface, listing entities related to the project, and a keyword cloud interface of keywords related to the project.

In exemplary embodiments the collaborator interface of the project profile may include a list of collaborators associated with the given project. By selecting, e.g., double clicking, a particular entity, an entity profile interface for that entity may be opened. In some embodiments, selecting, e.g., hovering over or single clicking, a particular entity in the project profile may update the keyword cloud interface for the project profile based on the selected entity, e.g., based on the selected entity's actual contributions to the project. In exemplary embodiments collaborators in the collaborator interface may be depicted/presented using an entity graph interface such as described herein.

As noted above, a project profile interface may include a keyword cloud interface which displays a set of top keywords for that project. In exemplary embodiments, selecting, e.g., clicking, keywords may run a query returning a set of top entities or set of top projects based on the selected keywords. Query results may be viewed and tunneled using, e.g., an entity results interface or project results interface, such as described herein. In further embodiments, selecting, e.g., hovering over, keywords in a keyword cloud interface of a project profile interface may update the collaborator interface to highlight those entities related to the selected keywords, e.g., those entities who's contributions to the project relate to the selected keywords.

Another exemplary data visualization interface for viewing and tunneling retrieved data, which may be employed by the systems and methods disclosed herein may include an entity group profile interface, e.g., for a queried/selected entity or entity group. In some embodiments, the entity group profile interface may include, basic group profile information, e.g., name, contact information, group summary, etc. and an entity graph interface depicting entities e.g., a set of top entities, related to the entity group. As with previous embodiments, the depicted entity graph interface may further be operatively associated with, a keyword cloud interface, e.g., depicting related keywords for the selected entity group and/or a related projects interface, e.g., depicting related projects for the selected entity group.

As with previous embodiments, the entity graph interface may include entity nodes which are characterized, e.g., scaled, according to a score for each entity group entity pair (entity group ID, entity ID), e.g., according to a degree of importance of each entity to the entity group. Connections between nodes may be used to represent collaborating entities and may be characterized, e.g., by thickness, color, etc., to represent, e.g., a degree of collaboration between entities.

In some embodiments, the keyword cloud interface may interdepend on the entity graph interface, e.g., such that a set of top keywords currently visible in the keyword cloud interface may be computed based on a set of top entities currently visible or selected in the entity graph interface. In some embodiments, selecting (e.g., hovering over, clicking, etc.,) keywords in the keyword cloud interface may run a new query or further modify, e.g., filter/narrow, a previously executed query based on the selected keyword query parameter(s), e.g., resulting in both the entity graph interface and keyword cloud interface being updated based on the updated query parameter(s). In some embodiments, a first form of selection of keywords (e.g., hovering over) may perform a different function than a second form of selection of keywords (e.g., clicking). For example, hovering over a keyword may filter/narrow a previous query whereas clicking on a keyword may run a new query.

In exemplary embodiments the entity graph interface may interact with the associated keyword cloud interface in several ways. A first interaction may occur, e.g., when a user selects, e.g., clicks on, hovers over, etc., nodes within the entity graph interface. Upon selecting one or more nodes, all nodes not directly connected to that nodes may be hidden. In other words, only a selected set of entities and their collaborators will be visible. The keyword cloud interface may likewise be updated to reflect only keyword data associated with the selected entities and their collaborators (e.g., the keyword data corresponds to the entities currently visible on the entity graph interface). In further exemplary embodiments a selection, e.g., double clicking, of a node within the entity graph interface may open an entity profile interface, including relevant information relating to the selected entity.

A second interaction between the keyword cloud interface and the entity graph interface may occur when a user selects, e.g., hovers over, keywords in the keyword cloud interface. Because, e.g., in some embodiments all keywords in the keyword cloud are computed from the entities reflected in the entity interface graph, each entity can be assigned a “contribution score” for each keyword in the keyword cloud. Thus, when a user selects, a keyword, the entity graph interface may update to hide all entities which have a contribution score of 0 and to re-characterize, e.g., re-scale the remaining nodes based on their contribution score.

In exemplary embodiments the entity graph interface may further interact with a related projects interface, including projects related to the selected entity group. In exemplary embodiments selections of nodes or connections in the entity graph interface and/or selection of keywords in the keyword cloud interface may update the related projects interface to highlight those projects related specifically the selected nodes (entities), connections (collaborations), and/or keywords. Similarly, a selection of, e.g., hovering over or clicking, projects in the related projects interface may update the entity graph interface and/or keyword cloud interface to reflect, e.g., only visualize, information (e.g., entities, connections, keywords, etc.) related to the selected projects. In some embodiments, a selection of, e.g., double clicking, a particular project in the related projects interface may open a project profile for the selected project. In exemplary embodiments projects in the related projects interface may be depicted/presented using a project graph interface such as described herein.

Another exemplary data visualization interface for viewing and tunneling retrieved data, which may be employed by the systems and methods disclosed herein may include a project group profile interface, e.g., for a queried/selected project or project group. In some embodiments, the project group profile interface may include, basic group profile information, e.g., name, project group summary, funding information, etc. and a project graph interface depicting projects e.g., a set of top projects, related to the project group. As with previous embodiments, the depicted project graph interface may further be operatively associated with a keyword cloud interface, e.g., depicting related keywords for the selected project group and/or a related entities interface, e.g., depicting related entities for the selected project group.

As with previous embodiments, the project graph interface may include project nodes which are characterized, e.g., scaled, according to a score for each project group project pair (project group ID, project ID), e.g., according to a degree of importance of each project to the project group. Connections between nodes may be used to represent related projects and may be characterized, e.g., by thickness, color, etc., to represent a degree of similarity/collaboration between projects. In some embodiments, related projects may be scored, e.g., based shared relationships with entities and/or keywords.

In some embodiments, the keyword cloud interface may interdepend on the project graph interface, e.g., such that a set of top keywords currently visible in the keyword cloud interface may be computed based on a set of top projects currently visible or selected in the project graph interface. In some embodiments, selecting (e.g., hovering over, clicking, etc.,) keywords in the keyword cloud interface may run a new query or further modify, e.g., filter/narrow, a previously executed query based on the selected keyword query parameter(s), e.g., resulting in both the project graph interface and keyword cloud interface being updated based on the updated query parameter(s). In some embodiments, a first form of selection of keywords (e.g., hovering over) may perform a different function than a second form of selection of keywords (e.g., clicking). For example, hovering over a keyword may filter/narrow a previous query whereas clicking on a keyword may run a new query.

In exemplary embodiments the project graph interface may interact with an associated keyword cloud interface in several ways. A first interaction may occur, e.g., when a user selects, e.g., clicks on, hovers over, etc., nodes within the project graph interface. Upon selecting one or more nodes, all nodes not directly connected to that nodes may be hidden. In other words, only a selected set of projects and their related projects will be visible. The keyword cloud interface may likewise be updated to reflect only keyword data associated with the selected projects and their related projects (e.g., the keyword data corresponds to the projects currently visible on the project graph interface). In further exemplary embodiments a selection, e.g., double clicking, of a node within the project graph interface may open a project profile interface, including relevant information relating to the selected project.

A second interaction between the keyword cloud interface and the project graph interface may occur when a user selects, e.g., hovers over, keywords in the keyword cloud interface. Because, e.g., in some embodiments all keywords in the keyword cloud are computed from the projects reflected in the project interface graph, each project can be assigned a “contribution score” for each keyword in the keyword cloud. Thus, when a user selects, a keyword, the project graph interface may update to hide all projects which have a contribution score of 0 and to re-characterize, e.g., re-scale the remaining nodes based on their contribution score.

In exemplary embodiments a project graph interface may further be operatively associated with a related entities interface, including entities related to the selected project group. In exemplary embodiments selections of nodes or connections in project graph interface and/or selection of keywords in the keyword cloud interface may update the related entities interface to highlight those entities related specifically the selected nodes (projects), connections (relationships between projects), and/or keywords. Similarly, a selection of, e.g., hovering over or clicking, entities in the related entities interface may update the project graph interface and keyword cloud interface to reflect, e.g., only visualize, information (e.g., projects, relationships between projects, keywords, etc.) related to the selected entities. In some embodiments, a selection, e.g., double clicking, a particular entity in the related entities interface may open an entity profile for the selected entity. In exemplary embodiments entities in the related entities interface may be depicted/presented using an entity graph interface such as described herein.

Another exemplary data visualization interface for viewing and tunneling retrieved data, which may be employed by the systems and methods disclosed herein may include an analytics tool interface for selecting and using various analytics tools to analyze query results. By way of example one type of analytics teal may be a heatmap for viewing geographic concentrations of returned query results (e.g., a heatmap may be used to visualize geographic concentration information for an identified (queried) set of entities and/or projects relating to particular keyword input parameters). Exemplary analytics tools which may be implemented using the systems and methods of the present disclosure may include but are not limited to the following:

Exemplary User Interface:

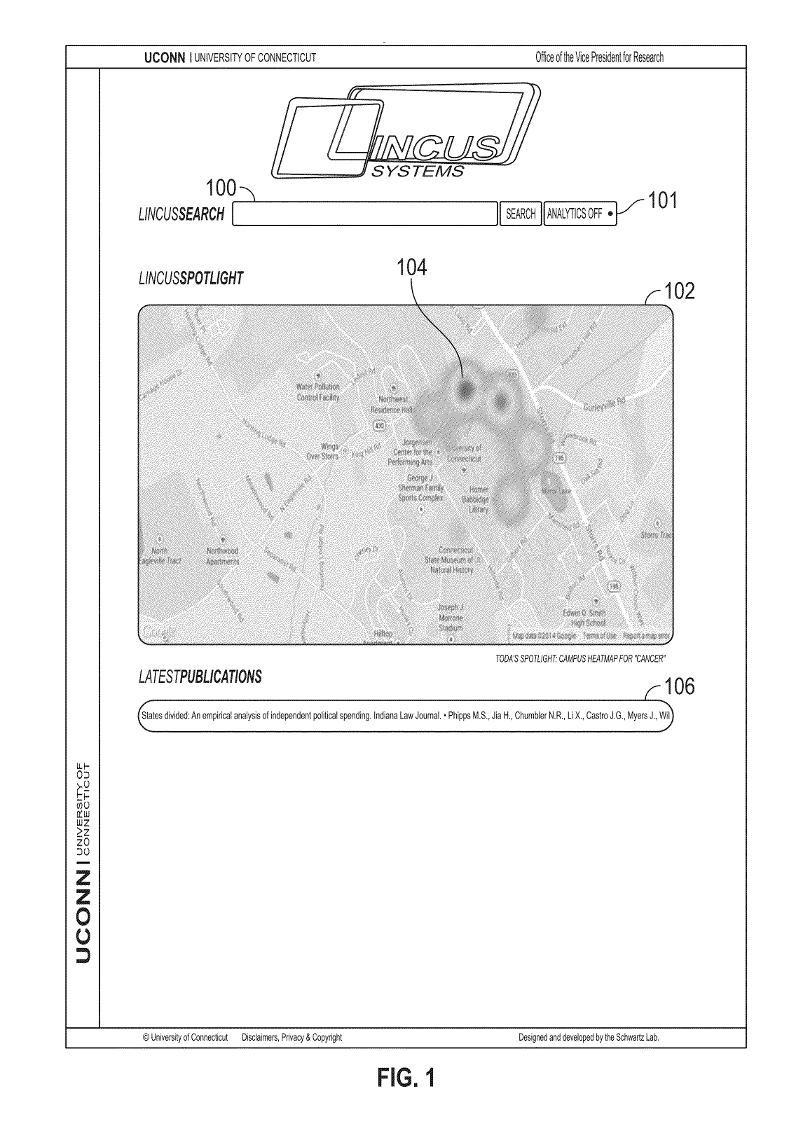

FIGS. 1-15 depict screenshots for an exemplary user interface implementing many of the data visualizations and manipulations described herein.

With initial reference to FIG. 1, a screenshot of an exemplary home/main page is depicted. The home/main page may include a search field 100 (query interface) which may be used to input search parameters for a particular query, e.g., keyword parameters. In exemplary embodiments, the search field 100 may query entities, projects, entity groups, project groups, etc., based on received user input. For example, a user can enter keywords, entity names, project names, entity group names, project group names, etc. Advantageously the search field 100 may be available one every page of the user interface. In exemplary embodiments, an analytics button 101 indicating whether analytics are turned on or off will be adjacent to the search field 100 As illustrated, in exemplary embodiments a main/home page may also provide, e.g., a spotlight section (typically a rotating visualization) of interesting information (such as recent query results/visualizations) and a recent publications section 106. For example, the illustrated spotlight depicts a heatmap 102 generated based on a query using a keyword “cancer” on the Storrs campus of the University of Connecticut (in which color intensities 104 denote areas on campus where research related to the keyword is being carried out).

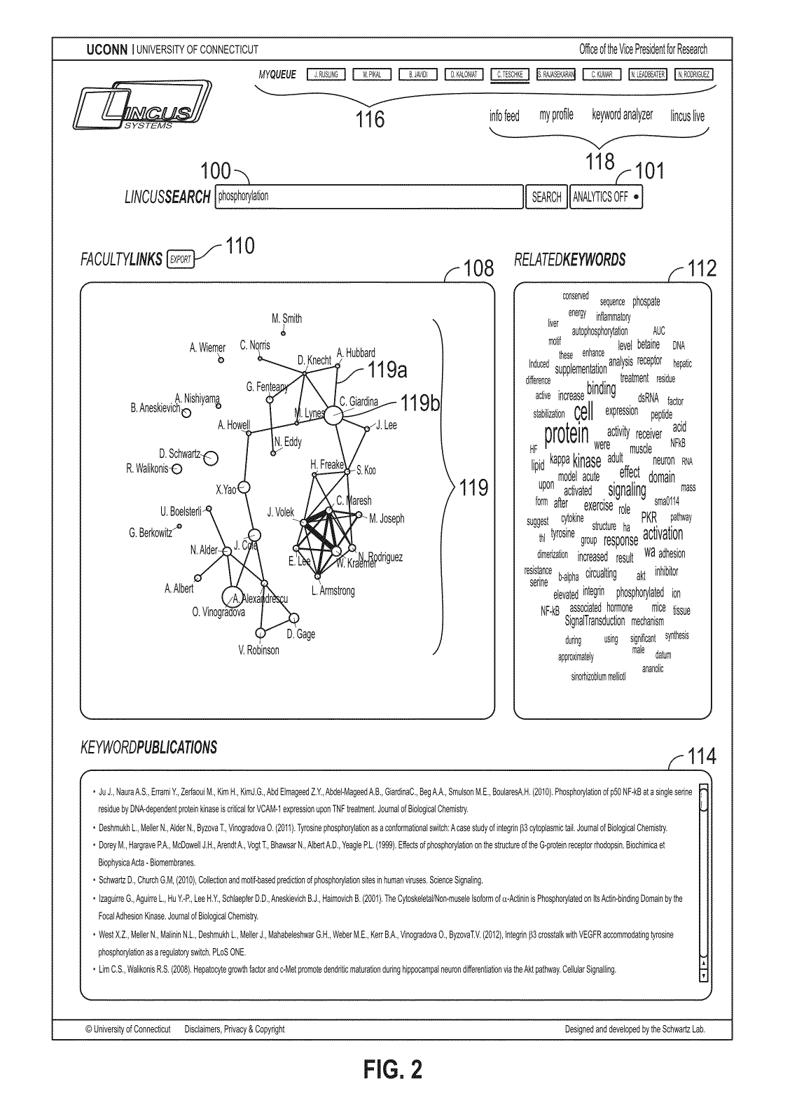

FIG. 2 depicts a screenshot of an exemplary entity results interface generated based on a query using the keyword “phosphorylation” in the search field 100. In the links sections 110, an entity graph interface 108 is depicted. Entity names 119 are associated with nodes 119b that are scaled proportionately to the importance of the searched keyword for that entity, and are color coded according to the entities' group membership (e.g., department at the University). Linkages 119a between nodes 119b are scaled proportionately to the number of shared projects (publications, grants, etc.) between the respective entities. In the keyword section, a keyword cloud 112 interface is depicted. The keyword cloud 112 interface provides keywords related to the entities displayed in the network diagram in the context of the initial keyword input. Keyword sizes in the cloud 112 are scaled relative to their degree of relevance, e.g., to the entity network in the entity graph interface. In the publications section, a related projects interface is depicted. As depicted, the projects results interface 114 depicted as the keyword publications interface includes a list of publications associated with the queried parameters. In exemplary embodiments, selecting, e.g., hovering over or clicking, a keyword in the keyword cloud interface will display the relevant entities associated with the keyword in the entity graph interface and will filter the publication list in the relevant projects interface to include the subset of publications containing the keyword in real-time.

A “MyQueue” 116 feature (which appears at the top of every web page depicted in FIGS. 1-15) is meant to be used in conjunction with the aspects of the systems and methods presented herein. The MyQueue feature 116 advantageously matches entities within an organization who are close in areas of interest, yet relatively distant by way of linkages within the organization (e.g., departmental/project based linkages). Thus the systems and methods of the present disclosure may promote the mutual introduction of such entities by identification thereof and by suggesting/enabling a brief video chat when two users from respective MyQueues are logged on at the same time.

In exemplary embodiments, toolbar 118 may be used to navigate through the user interface.

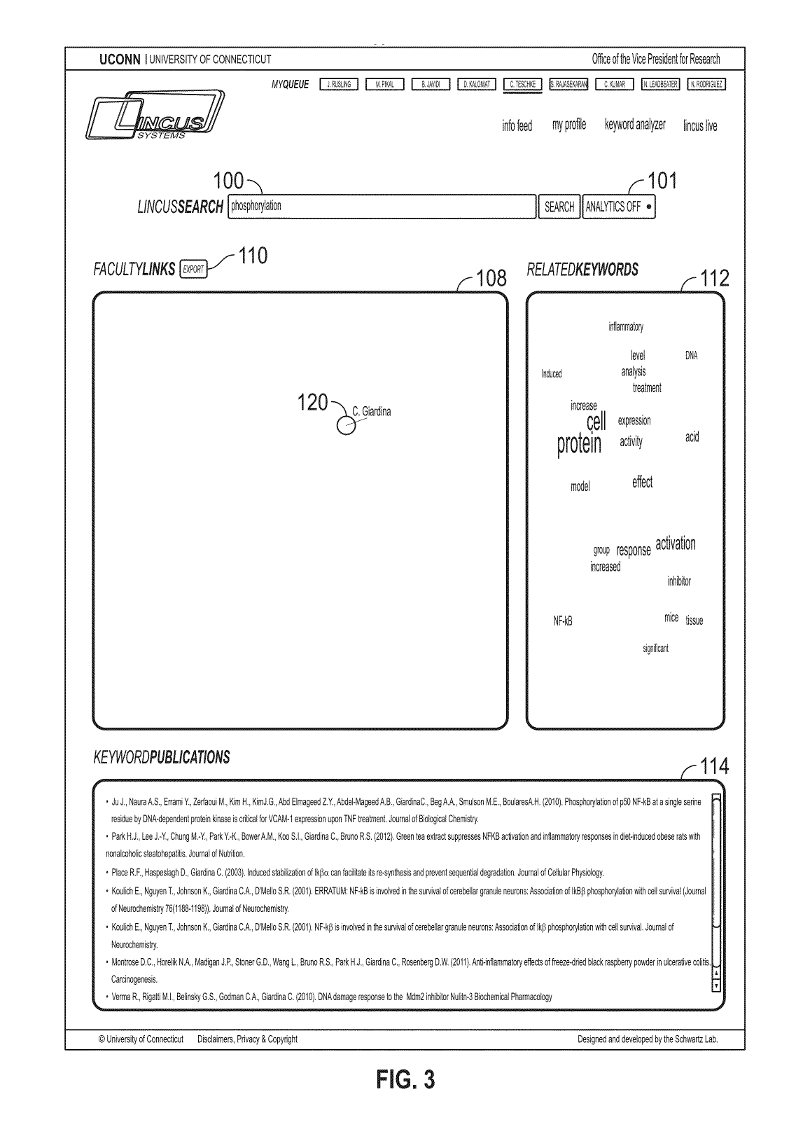

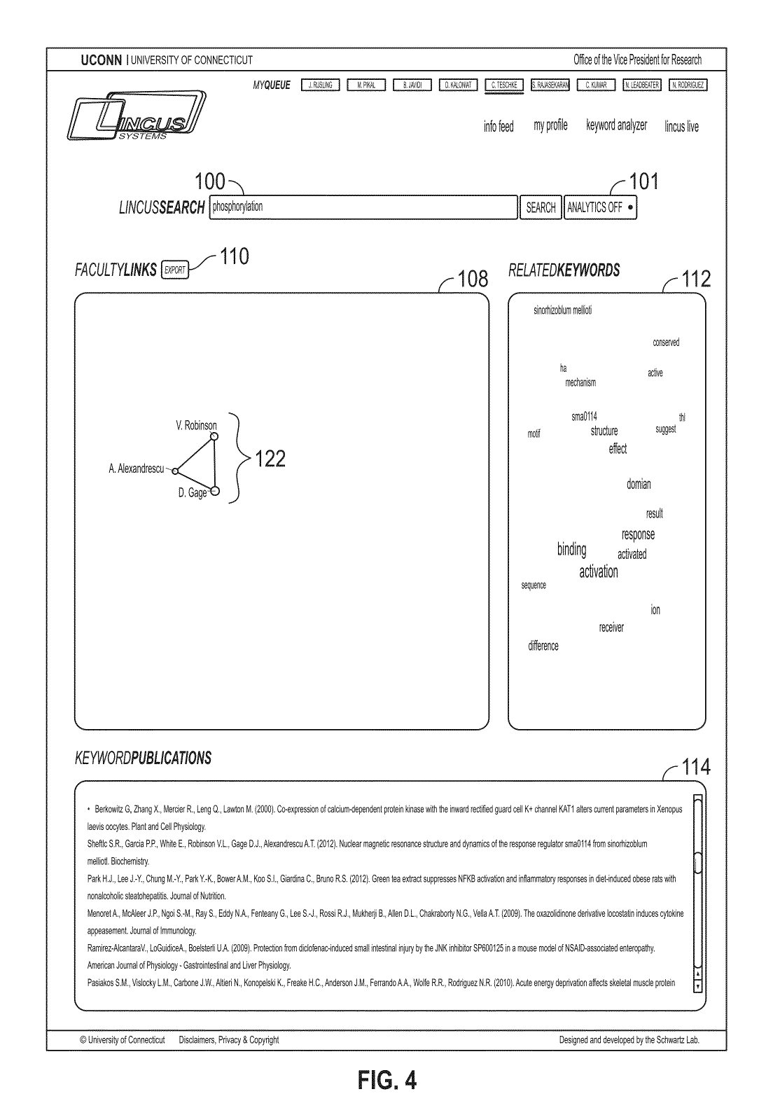

FIGS. 3-4 depict screenshots illustrating various interactive features of the exemplary entity results interface of FIG. 2. Turning to FIG. 4, in exemplary embodiments, selecting an entity's node 120 in the entity graph interface filters the word cloud in keyword cloud 112 interface and the publication list in the project results interface 114, accordingly. Turning to FIG. 4, in exemplary embodiments, selecting a publication in the project results interface 114 will filter the network graph 122 in the entity graph interface 108 and the related keywords in the keyword cloud interface 112, accordingly.

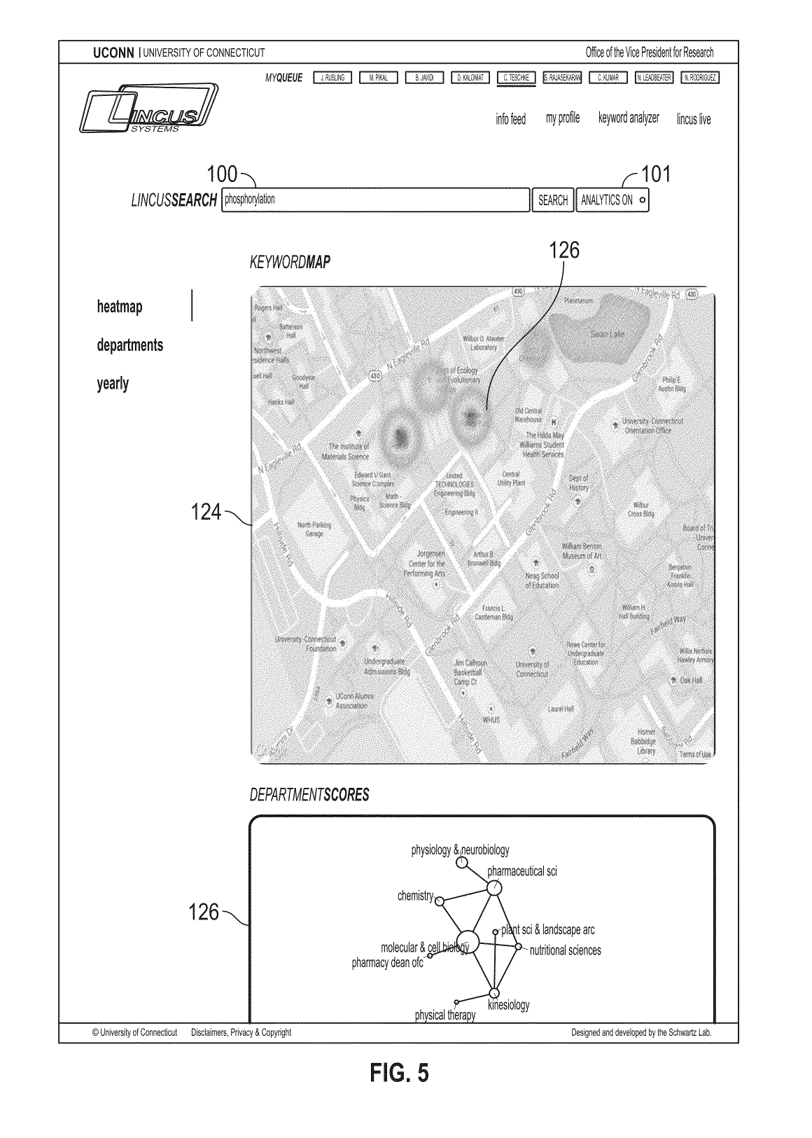

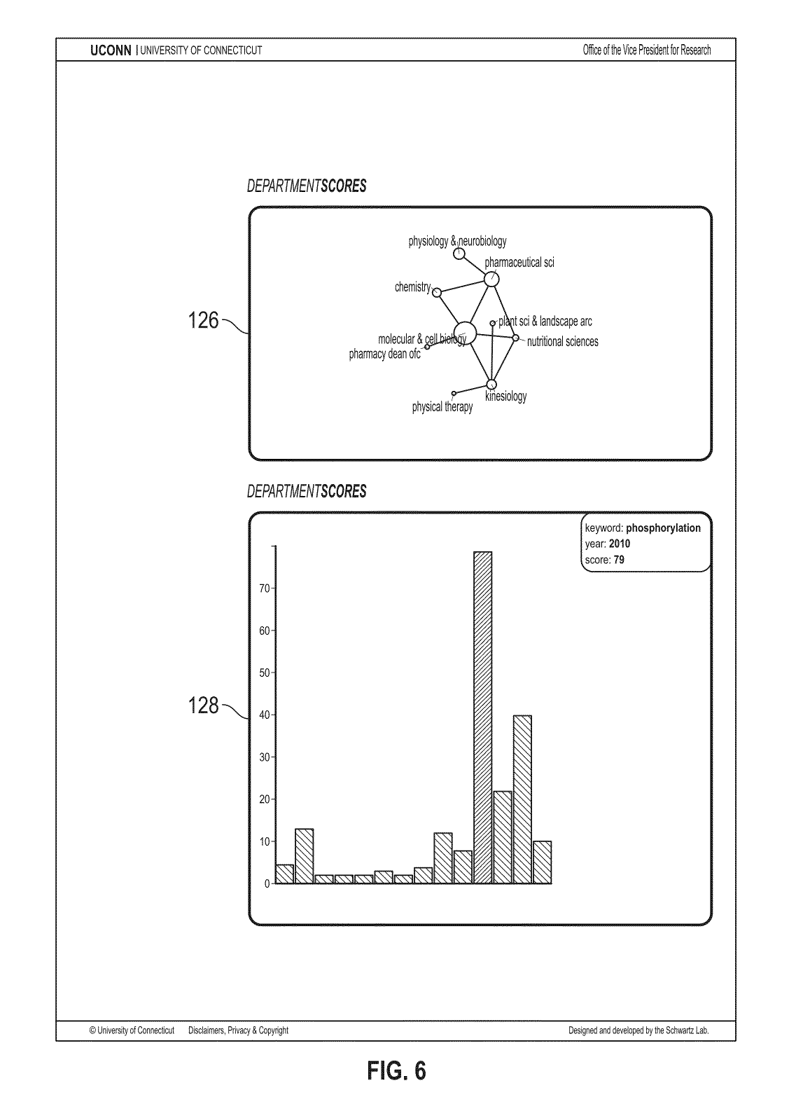

FIGS. 5 and 6 depict top and bottom portions of a screenshot illustrating exemplary analytics features for a query in the search field 100 which may be selected, e.g., by clicking the “analytics” button to the right of the search field. This sample analytics are for the searched term “phosphorylation.” Turning to FIG. 5, in exemplary embodiments, in the top portion of the user interface, the analytics include (i) a heatmap 124 illustrating the locations where “phosphorylation” research is being carried out on the Storrs campus of the University of Connecticut (as shown in FIG. 5), (ii) entity groups (departments) 126 associated with the keyword and the relationships between them (as shown in FIGS. 5 and 6) and (iii) scores 128 of the keyword displayed over time (as shown in FIG. 6).

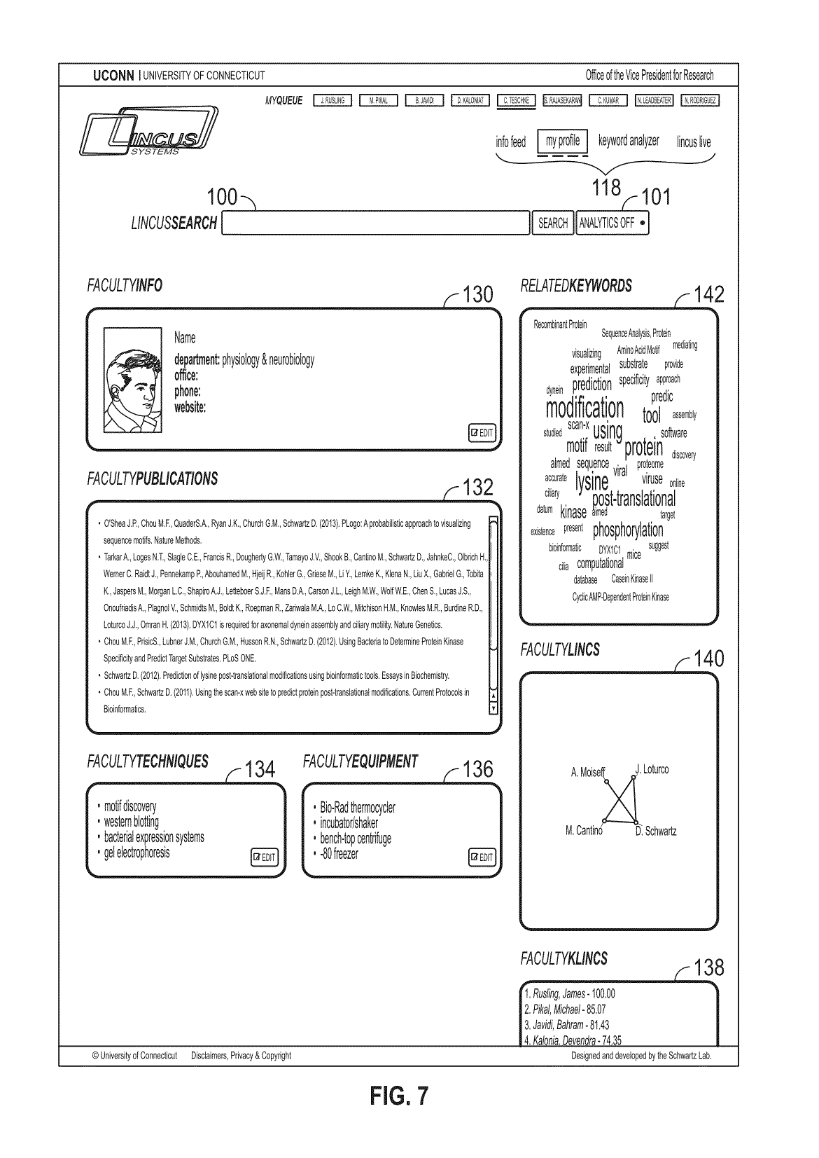

FIG. 7 depicts a screenshot of an exemplary entity profile interface which may be accessed, e.g., by typing in an entity's name into the search interface 100 or by selected a node from within the network diagram of an entity graph interface. The entity profile interface may include general entity profile information 130 such as a name, picture, contact information, biography information, areas of expertise, grants, techniques, equipment, etc. The provided information may depend on data availability (e.g., information sections may only appear when they are populated with data). The entity profile interface may further include a related projects (Publications) interface 132 and a keyword cloud interface 142 (Keywords). Advantageously, users may use a secure login procedure to log in and edit various sections of their entity profiles (denoted by an edit button at the bottom right of each section). In the depicted embodiments, the entity profile further includes an entity graph interface 140 and a related entities interface 134-138 providing information regarding related entities. Related entities may be identified, e.g., based on an algorithm that correlates keywords and other relevant features between entities and returns a ranked list of the most-closely related entities to the profiled entity. Notably, as with the entity results interface of FIGS. 2-4, sections of the entity profile interface may be linked and interactive. In exemplary embodiments, selecting a keyword in the word cloud of the keyword cloud interface may filters the related publications in the related projects interface.

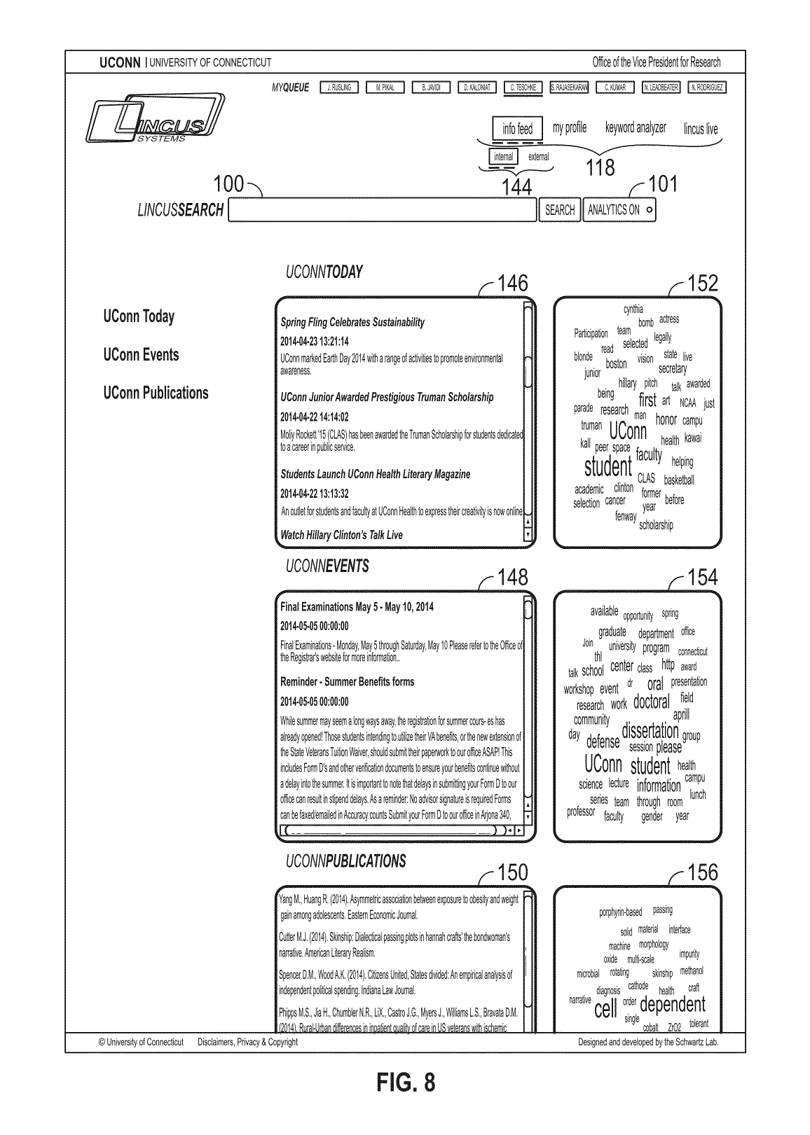

FIG. 8 depicts a screenshot of an exemplary customizable and interactive data feed interface that could contain selected data feeds, e.g., news, events recent publications, etc. In exemplary embodiments, the interactive data feed interface could be accessible by users logging on to their entity profiles and may provide customized news/information relevant to each entity's related keywords and/or based on user-adjustable parameters. In some embodiments, a learning algorithm may be employed to tailor results based on user preference (e.g., based on a characterization of which results a user demonstrates interest in such as by clicking on an result in the feed). In exemplary embodiments, when info feed is selected on the toolbar 118 the user is presented a sub toolbar 144 depicting options for internal and external news feed. In exemplary embodiments, the data feed may display data in various scrolling interfaces. For example, as shown in FIG. 8, a first interface 146 for a news feed for today is displayed, a second interface 148 for events is displayed and a third interface 150 for related publications/projects is displayed. In exemplary embodiments, the data feed interface may include a keywords cloud interface 152-156 located adjacent to the scrolling interfaces 146-148, e.g., derived from the entity profile for a logged in user. In exemplary embodiments, a user may select a keyword whereby subsets the feed data related to the selected keyword may be highlighted.

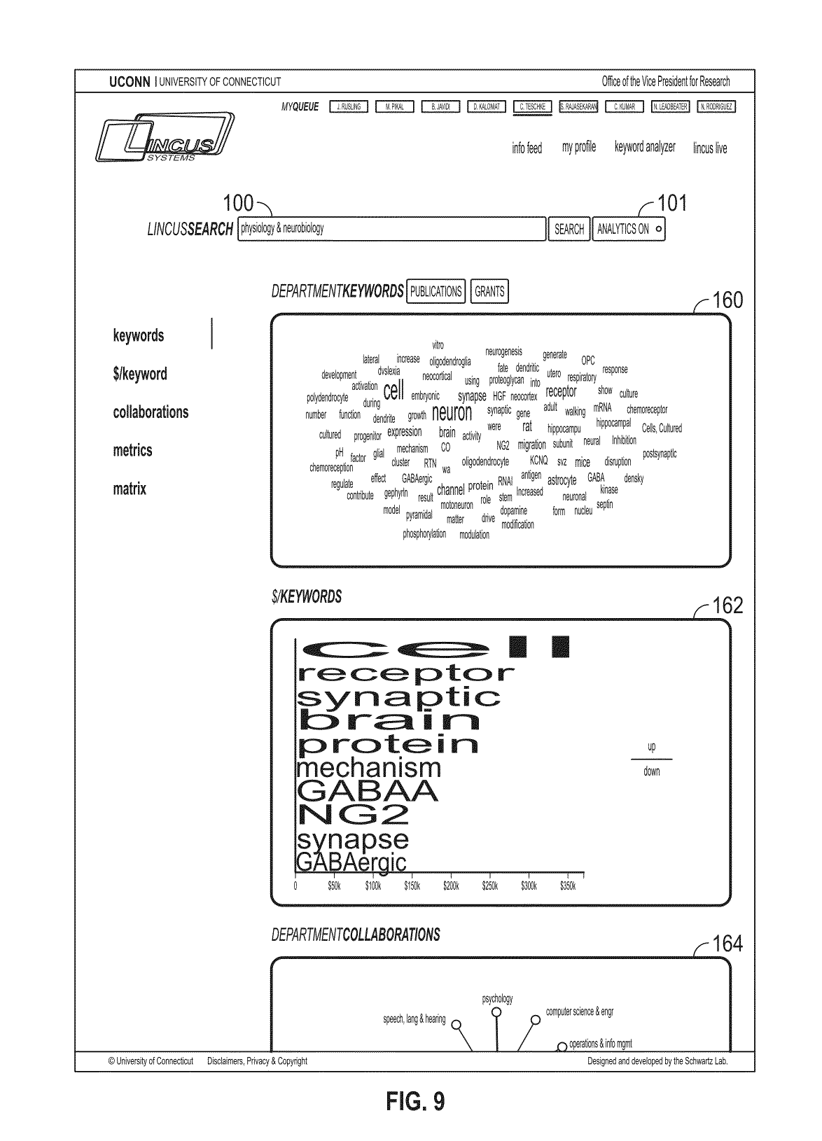

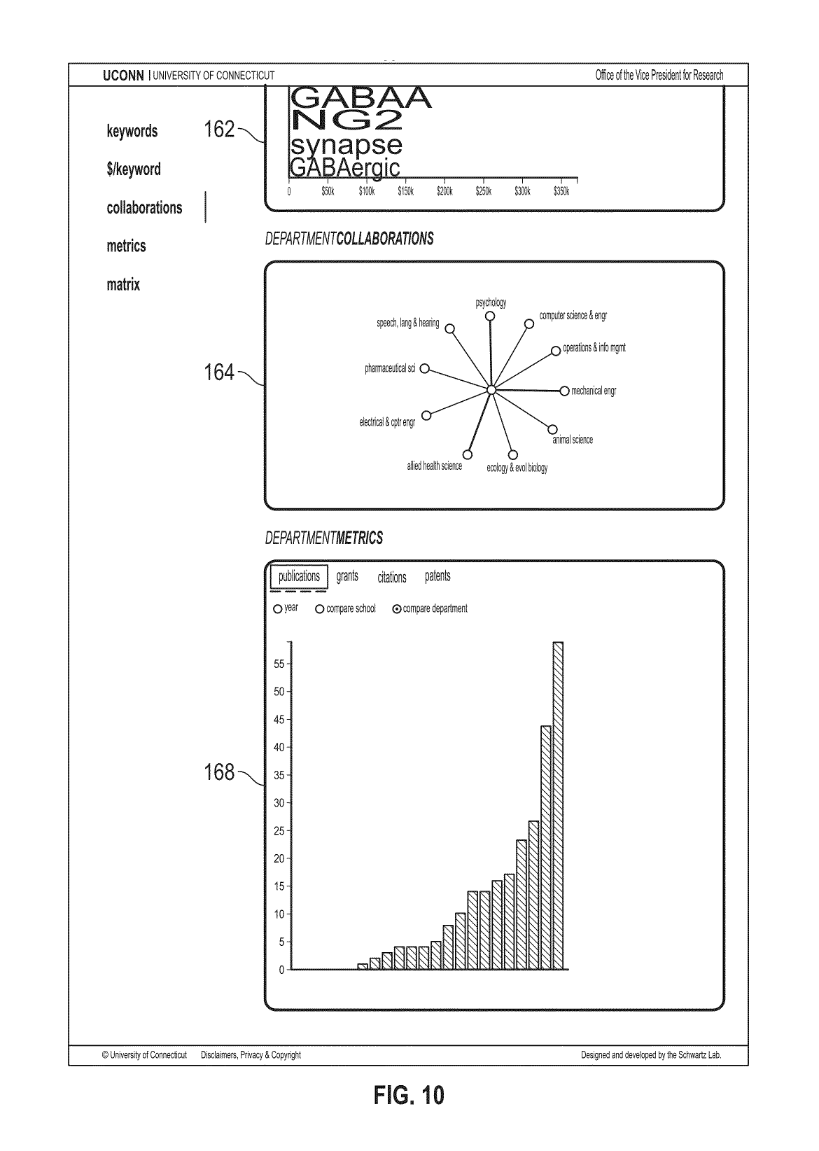

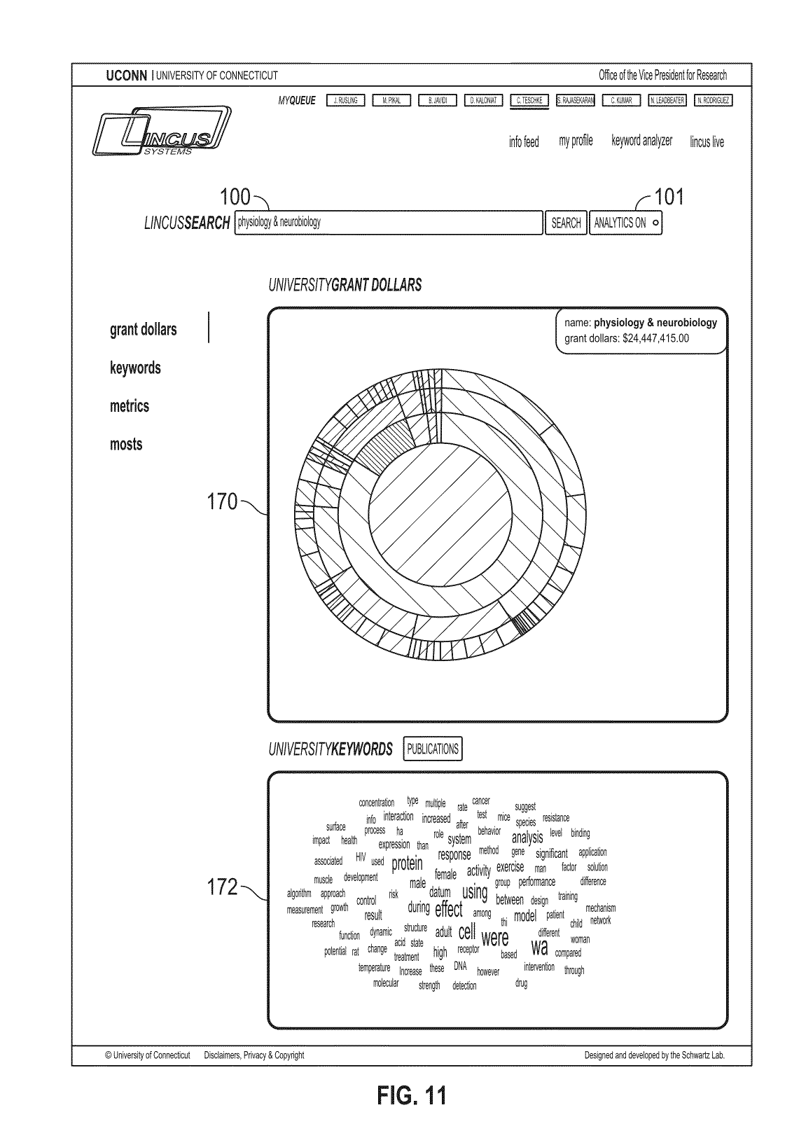

FIGS. 9-11 depict screenshots illustrate additional analytics that may be provided according to the systems and methods disclosed herein. FIGS. 9 and 10 are examples of single entity group type analytics which exhibit interactivity, e.g., by hovering over the visualizations. In exemplary embodiments, the user interface may display various interfaces depicting the entity group type analytics. For example, in FIG. 9 interfaces 160-162 may depict department keyword cloud interface and a department keyword graph respectively. In FIG. 10 interfaces 164-166 may depict department collaborations and department metrics. In contrast FIG. 11, depicts organization-wide analytics (e.g., involving multiple entity groups). In FIG. 11 interface 170 may depict visualization of university grant dollars and interface 172 may depict a organization-wide keyword cloud interface.

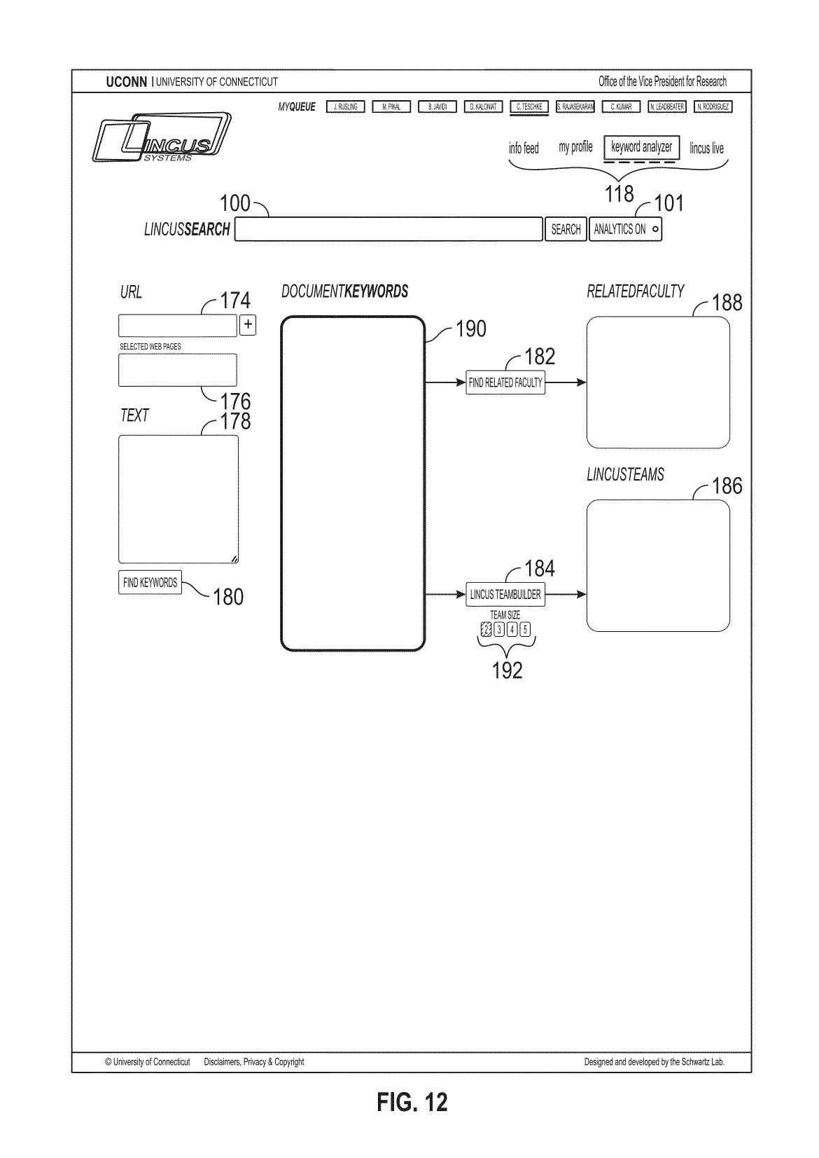

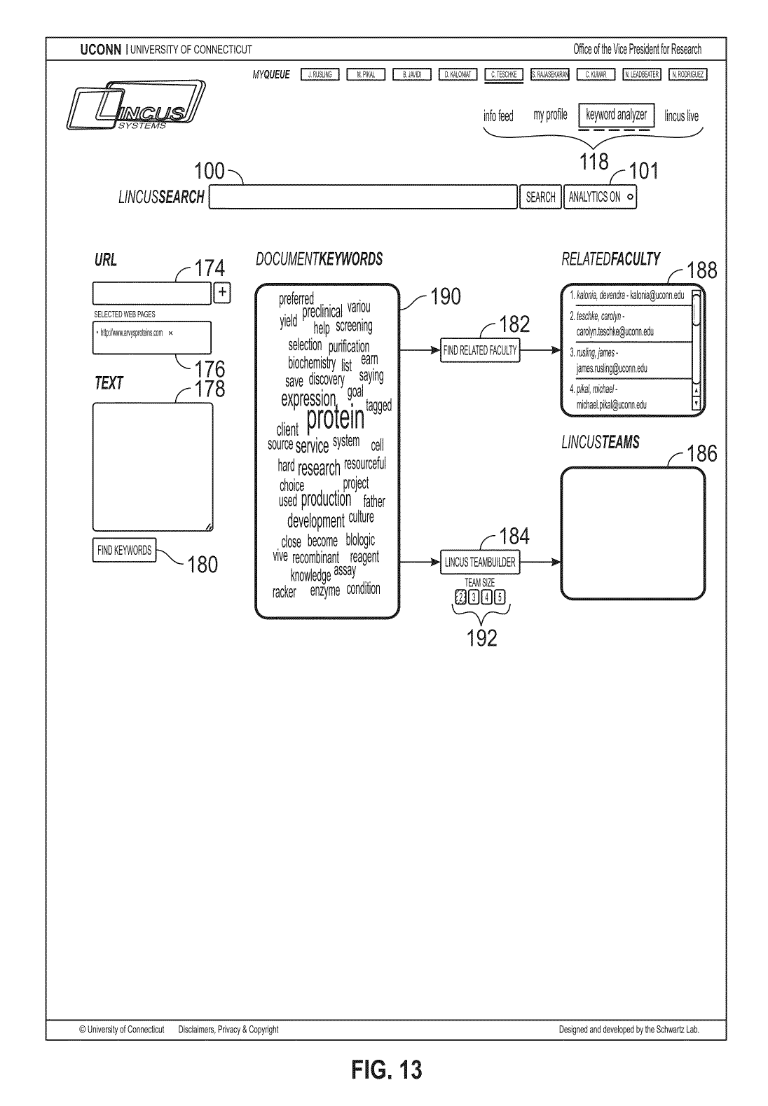

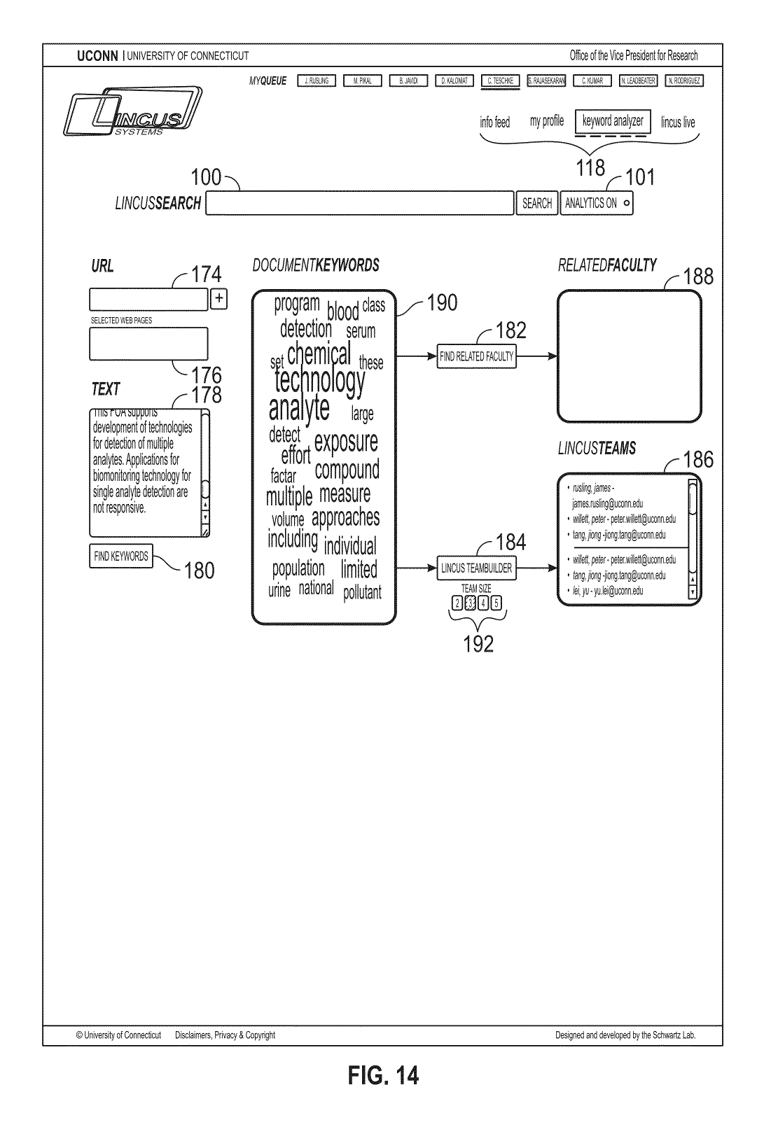

FIGS. 12-14 depict screenshots illustrating operation of a keyword analyzer (as shown in the toolbar 118) model which may be implemented according to systems and methods described herein. This model enables users to simply type/paste a URL into the text box 174 at the left and selecting the find keywords button 180, In response to selecting the find keywords button 180, the system may retrieve keywords from the URL in real-time. In exemplary embodiments, the selected URL 176 may be displayed below the text box 174. In another embodiments, keywords also be generated by entering text in the text box 178 (as shown in FIG. 14). The generated keywords will be displayed in the keyword cloud 190. Once keywords are generated, users are given the option of running a query based on the generated keywords, e.g., to identify related entities and/or entity sets (teams). Thus, if a user selects the find related faculty button 182 the system may computationally correlate each entity in the database to the generated keyword cloud 188 to identify and output a sorted list of the most relevant entities (as shown in FIG. 13). If, on the other hand, a user selects the Teambuilder button 184, the system will build a sorted list of teams of entities (of a size denoted by the user) that maximally capture the keywords within the keyword cloud in a manner that maximizes relevant expertise (as shown in FIG. 14). In exemplary embodiments, the user may select the team size 192 under the teambuilder button.

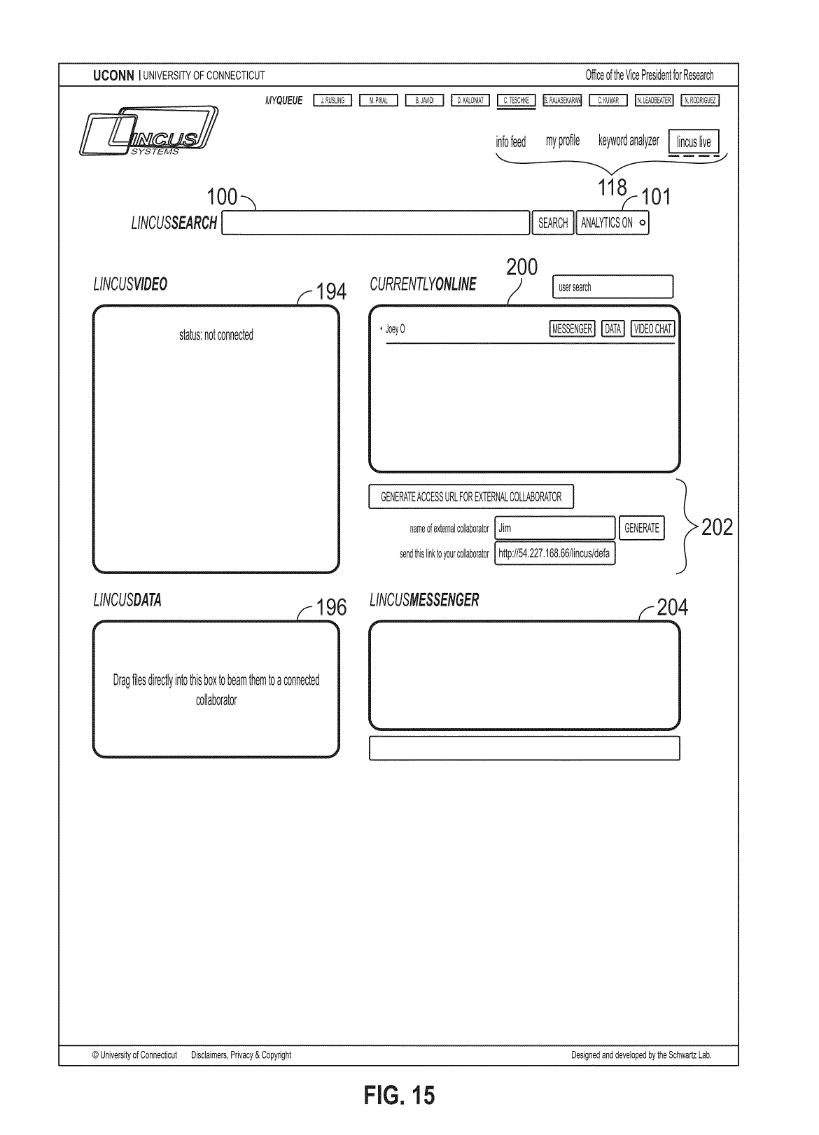

FIG. 15 depicts a screenshot of a social platform interface providing tools for collaborating with other users in real time as shown by the lincus live selection in toolbar 118. The social platform accomplishes the goal of enabling users to interact and create new connections with other users in a collaborative environment. This goes hand in hand with the querying and data analytics of the systems and methods described herein which facilitate identification of entities (e.g., other users) with pertinent areas of expertise. As depicted, there are components to the social platform interface including video 194, data 196, and messenger 204. In exemplary embodiments, the social platform interface may also indicate the users who are currently online using the currently online interface 200. In exemplary embodiments, users may also invite other users using the generate access URL for external collaborator button 202. Additional components which are not depicted (such as screen sharing) may also be implemented.

The video feature as shown in the video interface 194, allows users to spawn a video chat immediately and directly through their web browser using a newly developed internet protocol known as WebRTC. The system does not require flash or any other software downloads.

The data feature, as shown in the data interface 196 allows connected users to transmit any files through the system simply by dragging the file into the box in the browser. The file almost immediately appears on the other connected user's screen without any size limit restrictions.

The messenger feature, as shown in the messenger interface 204 allows users to message each other in a similar manner to other common messaging systems.

Advantageously, the system may allow logged-in users to generate an “access URL” for external collaborators. By sending external collaborators the generated access URL, users logged into the system can utilize all of the above features (video, data, and messenger) with any collaborator with a computer and an internet connection.

The systems and methods of the present disclosure may promote the mutual introduction of such entities by identification thereof and by suggesting/enabling a brief video chat using the video interface 194, when two users from respective MyQueues are logged on at the same time.

Additional System Features:

In exemplary embodiments one or more of the following additional system features may be implemented by the systems and methods disclosure herein:

Collaboration availability—Given that one exemplary function of the systems and methods described herein is to enhance collaboration, and that there can inevitably exist some individuals that would rather not collaborate, the system may prompt users at their first log on to the system to rate their “collaboration availability” or “desire to be contacted for collaborative activities” on a scale. Users can have the ability to change this parameter in their preferences.

Trending—The analytics portion of the software can include a trending feature which may be geared, e.g., for university administrators. This feature may perform various functions. First, it may allow administrators to view research areas within the institution that are identified to be “trending” positive or negative over time (as judged by a variety of parameters including, but not limited to, publications, citations, grants, and/or patents). Second, it can allow administrators to search the data for trends within areas of interest. For example, an individual in the communications department might be interested in using the systems and methods described herein to find all junior faculty in the area of “genomics” who have received >$500K funding and have published more than 4 papers in the past 5 years for the purpose of writing a feature news story. Third, the system may be able to capture trends of sources external to the institution and provide comparative analytics. For example, the system will be able to find trends in governmental grant opportunities and provide best-fit matches to existing faculty.

Probability-based matching—In exemplary embodiments, the keyword finder may be implemented as a probability-based system which calculates the statistical significance of each keyword relative to an appropriate background. Thus, non-specific keywords common to the background are automatically filtered from analyses without the need for complex part-of-speech parsing.

Correlational analysis for multi-keyword phrases—Keywords can often be grouped in clusters, for example, the term “protein post-translational modification” can be treated as a unit rather than as three independent keywords. To capture these grouped phrases an algorithm may be utilized which automatically detects statistically significant co-occurring word patterns.

These word patterns can be added into the keyword list as multi-keyword phrases, and can be included in all subsequent analyses.

Faculty matches—The queue feature described herein is meant to match individuals from within a university who share common research interests, but have not collaborated previously. It is also possible to match individuals who cite each other's research. This may be particularly useful for linking individuals across institutions who subscribe to the software service.

Versus Framework—A versus or comparison framework may be implemented which can effectively provide a side-by-side comparison on any desired metric (keyword, department, faculty, etc.). For example, one might be interested in performing a side-by-side comparison of total per capita federal grant dollars obtained by two departments or total number of research articles published in two areas of study. In exemplary embodiments, comparisons could also easily be made across institutions.

Tracking—A tracking feature can be used to record and analyze general usage behavior while on the associated web site. One purpose of the tracking system may be to perform internal analytics (i.e., to monitor network usage demands and to better understand the utility of various web functionalities).

Success—An evaluation feature may be including in connection with the tracking feature. In exemplary embodiments, the evaluation feature may quantify and correlate the success of future collaborations that were initiated through the systems and methods described herein, e.g., by tracking the first point of collaborative contact within the system and future co-authored publications, grants, patents, etc. The success feature can also enable users to note or provide feedback on successful collaborations initiated through the system.

Preferences—A standard preferences pane can be provided to users. The initial list of preferences may include: (i) the ability to set the length of time between successive queue alerts, (ii) the ability to set email/text notifications of messages received in the system,(iii) the ability to set a “collaboration availability” rating, and (iv) the ability to set internal and external news preferences, and the like.

Mobile—A mobile implementation of the systems and methods described herein may utilize mobile access platforms such as smartphones, tablets and the like. The mobile version can be a lighter version than the full system implementation and can focus on utilized integrated hardware such as video based functionalities and mobile connectivity options.

Whiteboard—a collaborative virtual whiteboard feature can be included that may be available to anyone using the social platform. The whiteboard can be a real-time communal writing space whereby all parties connected to a session could write and manipulate the board. The board may be accessible both via a web address as well as on mobile devices through a mobile application. In addition to having a variety of common drawing tools (particularly those useful for mathematical equation writing), at the end of a session, users may have the ability to save the contents of the board and have a screenshot of the board contents sent to their email.

Visual Teambuilder—A virtual teambuilder feature may be used to build a team as directed by a user. The system can start with a target keyword cloud (generated by parsing a target document provided by the user), and provide a list of potential team members. The user may then have the ability to add/exclude team members and view how the target and team keyword clouds change in real time. Multiple, alternate teams will be able to be built using this system.

Deep Linking—In exemplary web-based implementations every page/search with returned results can have its own unique URL, thus allowing users to bookmark specific pages/searches. This will also allow forward/back browser functionalities within the web site.

Advanced Typeahead—An advanced typeahead feature may provide additional data when users begin typing into the search bar. Examples include, data type (keyword, department, author, etc.), author department, author picture, department school, etc. The feature can additionally use a frequency heuristic to determining most-likely desired search terms.

Advanced Search—An advanced search feature may provide a means of performing Boolean operations (AND, OR, NOT) in searches. The system may additionally support nested operations. From a visual standpoint, data types and Boolean operations will be blocked and color-coded upon selection, thus distinguishing the department “Physiology and Neurobiology” from the search for two independent keywords “Physiology” AND “Neurobiology”.

Group Chat—A group chat feature can allow for a group video/audio conference with more than two (for example, up to six) users simultaneously. As with the previously described social platform, collaborators outside the system may be able to access the group chat feature by obtaining an auto-generated URL from an account holder.

Home page—In exemplary embodiments a home page may be set up as a customized user information dashboard. Because each user has a set of compiled associated keywords, information on the home page can be tailored to a user's existing interests without the need for user input. Items to be included on the home page include: i) news internal to the University, ii) news external to the University, iii) recent publications of interest by University faculty, iv) recent publications of interest outside the University, v) events/seminars internal and external to the University, vi) relevant grant opportunities, vii) private messages from users within the system, viii) updates on followed users, ix) relevant Twitter feeds, and the like

Following—A follow feature may enable users to follow other users, entities, projects, etc. Followers may receive updates (grants, publications, etc.) for the items they elect to follow.

Private messaging—A private messaging feature may be implemented which can provide the ability to send and receive private messages within the system. This functionality may differ from a live messaging service in that it may not require both users to be logged into the web site. Users will be able to select from a variety of private message notification options including email and text.

Public messaging—A public messaging feature can also be implemented to provide the ability to send and receive messages to larger groups of individuals. It might be used by administrator to send a university-wide message, or a faculty member to send an interesting news story to followers.

File/data storage/sharing—In exemplary implementations the system may allow users to organize and store files directly on their personal home page. Users may also have the ability to select from a variety of sharing options (e.g., private, accessible to defined users, open to the world).

Degrees of separation—A degree of separation feature may be used to analyze (e.g., quantify) a degree of connectivity between entity pairs, project pairs, or the like. In addition to being provided as a widget on the web site, the connectivity calculation may also be used to determine the most appropriate matches for populating the queue functionality.

Creation of collaborative groups—In addition to the existing University groups which exist in the current system (e.g., departments, institutes, centers, etc,), the system may allow for the dynamic creation of collaborative groups. These groups may be able to be designated as either temporary (as in the creation of a working group for a new project or University committee), or permanent (as in the creation of a new University sponsored center). In addition to being able to view analytics for all groups in the system, administrators will be able to create hypothetical groups to view the relative strengths/weaknesses of the group using analytics prior to group formation.

System Implementations:

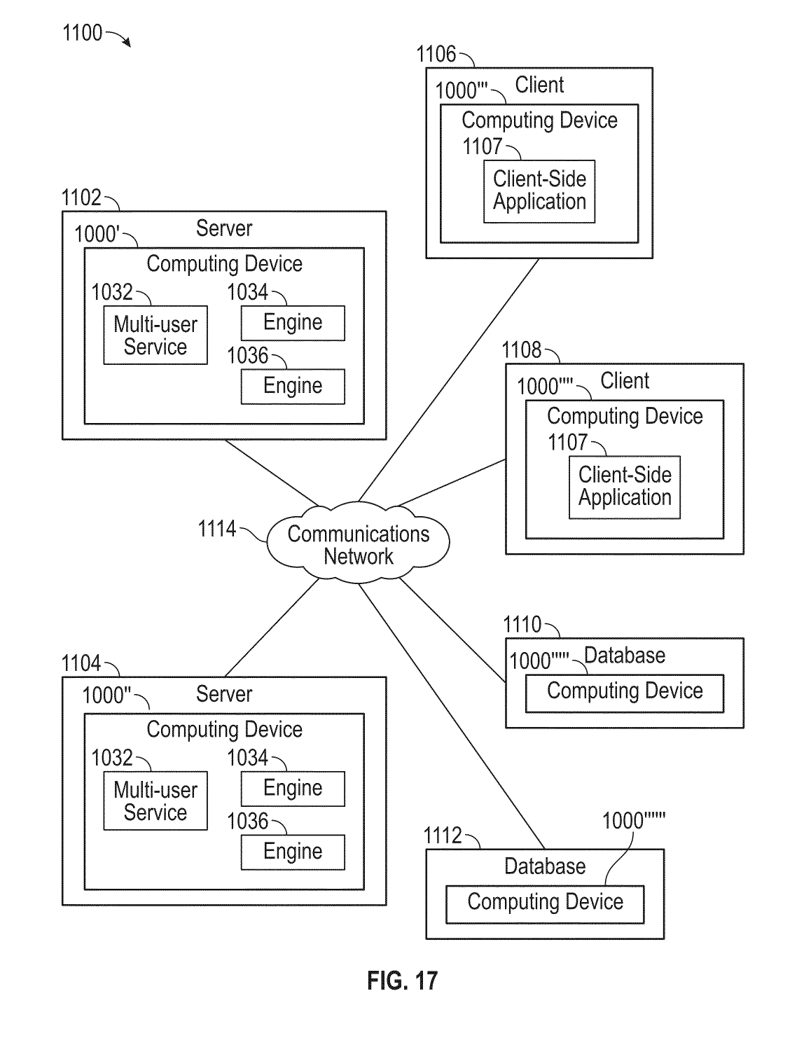

FIG. 17 is a block diagram of an exemplary network environment 1100 suitable for a distributed implementation of exemplary embodiments. The network environment 1100 may include one or more servers 1102 and 1104, one or more clients 1106 and 1108, and one or more databases 1110 and 1112, each of which can be communicatively coupled via a communication network 1114, such as the network 120 of FIG. 1. The servers 1102 and 1104 may take the form of or include one or more computing devices 1000′ and 1000″, respectively. The clients 1106 and 1108 may take the form of or include one or more computing devices 1000′″ and 1000″″, respectively. Similarly, the databases 1110 and 1112 may take the form of or include one or more computing devices 1000′″″ and 1000″″″. While databases 1110 and 1112 have been illustrated as devices that are separate from the servers 1102 and 1104, those skilled in the art will recognize that the databases 1110 and/or 1112 may be integrated with the servers 1102 and/or 1104 and/or the clients 1106 and 1108.

The network interface 1012 and the network device 1022 of the computing device 1000 enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on client 1106 and/or 1108 to allow users of client 1106 and/or 1108 to access and interact with a multi-user service 1032 installed on the servers 1102 and/or 1104. For example, the users of client 1106 and/or 1108 may include users associated with an authorized user group and authorized to access and interact with the multi-user service 1032. In some embodiments, the servers 1102 and 1104 may provide client 1106 and/or 1108 with the client-side applications 1107 under a particular condition, such as a license or use agreement. In some embodiments, client 1106 and/or 1108 may obtain the client-side applications 1107 independent of the servers 1102 and 1104. The client-side application 1107 can be computer-readable and/or computer-executable components or products, such as computer-readable and/or computer-executable components or products for presenting a user interface for a multi-user service. One example of a client-side application is a web browser that allows a user to navigate to one or more web pages hosted by the server 1102 and/or the server 1104, which may provide access to the multi-user service. Another example of a client-side application is a mobile application (for example, a smart phone or tablet application that can be installed on client 1106 and/or 1108 and can be configured and/or programmed to access a multi-user service implemented by the server 1102 and/or 1104.

The databases 1110 and 1112 can store user information, inventory data and/or any other information suitable for use by the multi-user service 1032. The servers 1102 and 1104 can be programmed to generate queries for the databases 1110 and 1112 and to receive responses to the queries, which may include information stored by the databases 1110 and 1112.

Exemplary embodiments of the systems and methods described herein were implemented on an Amazon EC2 instance running the Ubuntu Linux operating system with uWSGI and nginx running the web server. The primary web application, e.g., described with respect to FIGS. 1-18 was written in Python using the web2py framework. The exemplary user interface is built on top of the Twitter Bootstrap framework and AngularJS. The application utilizes two databases: one MySQL database for relational data and a MongoDB database for storing some precomputed keyword analysis results (see Keyword Analysis section for details). The web2py database abstraction layer is used to access MySQL and the PyMongo distribution is used for connecting to the MongoDB instance from the web2py application.

Storing precomputed keyword analysis data in a database is advantageous because it allows for rapid retrieval of search results. A large amount of data is required to generate the visualizations described herein, and thus generating this data on request would be inefficient. By precomputing and storing search result data as JSON documents in a database such as MongoDB, the application is able to return results in a near real-time manner. Although the exemplary application was built with MongoDB and MySQL, it could be adapted to work with any database

Real time communication on the web site (including video/voice, chat, and file sharing) is handled by one or more NodeJS servers. One server runs a socket.io instance which handles the mapping of user accounts to WebRTC sessions. This is necessary because a single user can have multiple WebRTC sessions active at any one time (e.g., user has multiple tabs open to the web site) so the web application must be able to convert from a user ID to a valid WebRTC session ID in order to make calls. A second NodeJS server runs the EasyRTC web server and handles the process of allowing users to request video/voice calls and accept or reject incoming calls, as well as the setup of peer-to-peer communication via STUN. In cases where STUN will not work due to firewall restrictions of NAT issues, a separate TURN server will be used to allow the real time communication to function. The TURN server will be run on its own Amazon EC2 instance. This is to ensure the server loads for real time communication and the primary web application will not interfere with each other and both can be scaled independently as needed.

WebRTC is a new technology which provides a way for web browsers to allow users to voice call, video chat, or even send files in a peer to peer manner. The WebRTC API is currently a draft by the World Wide Web Consortium (W3C). The technology was originally revealed by Google in 2011 and the latest W3C draft was released in September 2013. It is currently supported by Chrome, Mozilla, and Opera.

WebRTC is used by the application to provide peer-to-peer video chat, screen sharing, voice calling, and file transfers. This technology gives users an easy to use and highly interactive web interface which can be used to collaborate with their colleagues. Users are able to video or voice chat (as selected by the user), as well as send files to the person they are chatting with. Additionally, users are able to use a text based chat interface, allowing them to communicate with other users even if they do not have a microphone or camera available. By integrating all these features into a single web interface, users can focus on collaboration without the need to continually switch tabs or windows to use other applications. Screen sharing will further work to foster collaboration by giving users an easy way to send a video feed of their computer screen to another user. This can be used for purposes of demonstration and teaching as well as general collaboration on a project. EasyRTC framework was used to build all these WebRTC features into the web site. EasyRTC is a free open source software package. It includes both a back-end NodeJS signaling server to handle the setup of WebRTC connections and a front-end library to connect users via the signaling server.

Exemplary visualizations are powered by the D3JS framework as well as AngularJS. Data for visualizations is provided by a back-end data source. Communication with the data source server is done via AJAX using JSON as the format for data exchange.

### Further Exemplary Applications

In exemplary embodiments, the systems and methods described may be adapted for various other applications both inside and out of the academic world such as:

Resume type applications—For example, a system may be geared toward graduate and post-doctoral trainees (undergraduates will not be prepopulated in the system, but will have the ability to create profiles). A “Scholar” system may not only be used to create a graduate/postdoc collaboration network within an institution, but may also be utilized by employers seeking employees with particular skill sets (students may have the ability to include additional CV-like information on the system).

Meetings or conference type applications—For example, a system could be deployed at scientific conferences to allow for, i) easy navigation of conference proceedings, ii) visualization of linkages among conference attendees, iii) a framework for interaction during the conference (messaging, chat, meeting scheduling, etc.), iv) a framework for continued communication/networking that can persist throughout the year.

Corporate type applications—such as applied to enable analysis of relationships, knowledge areas, collaborations, etc., e.g., in a corporate setting, such large research and development companies, a law firm or other legal setting, medical/healthcare setting, and the like. For example in the health care setting a system could be deployed for physician-physician collaborations/interactions or for connecting medical specialists with academic basic science researchers to improve “bench to bedside” outcomes or for enabling patients to quickly find specialists in a particular medical area.

Non-profit type applications—For example, a system could be deployed geared toward university foundations. The system may include the ability for faculty to create a “wishlist” for their research programs and would allow potential donors to both search for and maximize the impact of their donations. For example, the system would be able to tell a prospective donor the dollar amount necessary to cover the wishlists of all faculty with prescribed characteristics performing “cancer research” at a given institution. Alternatively, the system could tell a prospective donor the smallest donation needed to cover the largest segment of researchers at an institution (i.e., through overlaps in wishlists).

While the present disclosure has described specific examples including presently preferred modes of carrying out the disclosed systems and methods, those skilled in the art will appreciate that there are numerous variations and permutations of the above described systems and methods. Thus, the spirit and scope of the invention should be construed broadly as set forth in the appended claims.

What is claimed is:

1. A system comprising:
a non-transient storage medium, the storage medium storing in a database, for each of a plurality of objects, object-keyword relationship information directly or indirectly relating the object to one or more keywords; and
a processor in communication with the non-transient member medium, the processor configured to execute instructions for determining, for at least a first keyword in the database, one or more related keywords wherein the one or more related keywords are determined based on:
(i) determining one or more objects related to the at least a first keyword based on the object-keyword relationship information for the at least at least a first keyword; and
(iii) determining the one or more related keywords based the object-keyword relationship information for one or more objects related to the at least a first keyword.

2. The system of claim 1, wherein the objects in the database represent entities and projects, wherein the object-keyword relationship information for the entities is entity-keyword relationship information, the object-keyword information for the projects is project-keyword relationship information,

3. The system of claim 2, wherein the entities and projects are in a university or other scholastic scholarly setting, research and development setting, or healthcare setting.

4. The system of claim 2, wherein the entity-keyword relationship information for each of entity includes information directly relating the entity to the one or more keywords and the entity-keyword relationship information for each entity includes (i) entity-project information directly relating the entity to one or more projects where the entity in a contributing entity and (ii) project-keyword relationship information directly relating each project to one or more keywords.

5. The system of claim 4, wherein the project-keyword relationship information is automatically derived by a processor analysis of data relating to each project and the processor analysis of data relating to each project includes at least one of (i) a semantic analysis or (ii) metadata analysis.

6. The system of claim 1, wherein the storage medium also stores in the database, for each of the plurality of objects, object-object relationship information directly or indirectly relating the object to one or more related objects.

7. The system of claim 6, wherein the objects are at least one of entities, in a collaborative environment wherein the object-object relationship information is entity-entity relationship information which directly or indirectly relates each entity to one or more collaborative entities or projects in a collaborative environment wherein the object-object relationship information is project-project relationship information which directly or indirectly relates each project to one or more related projects.

8. The system of claim 7, wherein the entity-entity relationship information for each of entity includes information directly relating the entity to the one or more collaborative entities and the project-project relationship information for each of project includes information directly relating the project to the one or more related projects.

9. The system of claim 8, wherein the entity-entity relationship information for each entity includes entity-project information relating the entity to one or more projects where the entity is a contributing entity, wherein the one or more collaborative entities for each entity are one or more other contributing entities to the one or more projects related to the entity and the project-project relationship information for each project includes project-entity information relating the project to one or more contributing entities to that project, wherein the one or more related projects for each project are one or more other projects related to the contributing entities to the project.

10. The system of claim 9, wherein the entity-entity relationship information for each entity includes entity-entity group information relating the entity to one or more entity groups where the entity is a member, wherein the one or more collaborative entities for each entity are one or more other member entities to the one or more entity-groups related to the entity and the project-project relationship information for each project includes project-project group information relating the project to one or more project groups where the project is a part thereof, wherein the one or more related projects for each project are one or more other projects in the one or more project-groups related to the project.

11. The system of claim 7, wherein for each entity the one or more collaborative entities are other entities that have collaborated with that entity at some point in the past.

12. The system of claim 6, wherein the determining the one or more objects related to the at least a first keyword includes determining a primary set of one or more objects related to the at least a first keyword based on the object-keyword relationship information for the at least at least a first keyword, and further determining a secondary set of additional objects related to the primary set of objected based on the object-object relationship information.

13. The system of claim 1, wherein the determining the one or more related keywords includes determining a ranking of a set of related keywords.

14. The system of claim 13, wherein the wherein the determining the one or more related keywords further includes applying a threshold to the ranking of the set of related keywords, wherein the threshold is at least one of (i) a subset of a predetermined maximum number of keywords; (ii) a subset of a predetermined minimum number of keywords or (iii) a subset of those keywords ranked above a certain value.

15. The system of claim 13, wherein the object-keyword relationship information includes a weighting factor for each object-keyword relationship, wherein the ranking of the plurality of related keywords is based at least in part on the weighting factors.

16. The system of claim 15, wherein the object-keyword relationship information includes two different weighting factors for each object-keyword relationship, depending on whether the relationship is from the perspective of the object to the keyword or from the perspective of the keyword to the object.

17. The system of claim 1, wherein the processor is configured to, (i) receive the at least a first keyword as a user input in a query, (ii) automatically parse a query to determine when the query includes one or more keywords and (iii) identify a plurality of entities passed on the query wherein the identification of the plurality of entities is based on a determining one or more entities related to the at least a first keyword based entity-keyword relationship information stored in the database.

18. The system of claim 17, wherein prior to processing the query, related keyword information and entity-keyword information is precompiled for each keyword in the database.

19. The system of claim 17, wherein the identification of the plurality of the plurality of entities includes determining a ranking of a set of entities related to the at least a first keyword by applying a threshold to the ranking of the set of related entities, wherein the threshold is at least one of (i) a subset of a predetermined maximum number of entities; (ii) a subset of a predetermined minimum number of entities or (iii) a subset of those keywords ranked above a certain value.

20. The system of claim 19, wherein the entity-keyword relationship information includes a weighting factor for each entity-keyword relationship, wherein the ranking of the set of entities related to the at least a first keyword is based at least in part on the weighting factors.

21. The system of claim 18, wherein the processor is further configured to determine for each entity in the identified plurality of entities a collaborative relationship relative to each of the other entities in the plurality of entities.

22. The system of claim 21, further comprising a display, wherein the processor is configured to drive the display to graphically depict the identified plurality of entities represented by points and the collaborative relationships between the entities represented by connections between the set of points.

23. The system of claim 22, wherein the processor is further configured to drive the display to visually depict a word cloud of the related keywords and the depicted word cloud of related keywords and the graphical depiction of the identified plurality of entities and the collaborative relationships between the entities are interrelated such that a user selection in one depiction is automatically reflected in the other depiction.

24. The system of claim 23, wherein a user selection of a keyword in the keyword cloud automatically filters the graphical depiction of the identified plurality of entities and the collaborative relationships between the entities to display only those entities and relationships associated with that keyword.

25. The system of claim 24, wherein a user selection of an entity or relationship in the graphical depiction of the identified plurality of entities and the collaborative relationships between the entities automatically filters the word cloud to include only those keywords associated with the selected entity or relationship.

26. The system of claim 25, wherein the processor is further configured to drive the display to visually depict a set of projects associated with the identified plurality of entities.

27. A method for determining, for at least a first keyword in a database, one or more related keywords, the method comprising:
storing, in a database located in a non-transient storage medium, the storage medium an object-keyword relationship information directly or indirectly relating the object to one or more keywords for each of a plurality of objects; and
determining, via a processor in communication with the non-transient member medium, one or more related keywords for at least a first keyword in the database, wherein the one or more related keywords are determined based on:
(i) determining one or more objects related to the at least a first keyword based on the object-keyword relationship information for the at least at least a first keyword; and
(iii) determining the one or more related keywords based the object-keyword relationship information for one or more objects related to the at least a first keyword.
